(19) United States
(12) Patent Application Publication
(10) Pub. No.: US 2004/0133408 A1
(43) Pub. Date: Jul. 8, 2004

(54) Modeling method for taking into account thermal head and ambient temperature

(76) Inventor: Dirk Verdyck, Schoten (BE)

Correspondence Address: HOFFMAN WARNICK & D'ALESSANDRO, LLC, 3 E-COMM SQUARE, ALBANY, NY, 12207

(21) Appl. No.: 10/738,931

(22) Filed: Dec. 17, 2003

Related U.S. Application Data
(60) Provisional application No. 60/440,471, filed on Jan. 15, 2003.

(30) Foreign Application Priority Data
Dec. 17, 2002 (EP) 02102776.8

(51) Int. Cl. G06F 17/10

(52) U.S. Cl. 703/2

(57) ABSTRACT

The present invention relates to thermal printing or thermography, more specifically to the generation of a mathematical model of the thermal steady state printing characteristics of a thermal printing system, and the use of such model for the driving of a thermal print head.

A method is described for building a steady state thermal model for a thermal print head when printing an image on a graphical medium. It is based on a calibration printout on the graphical medium under consideration. The constraints for this calibration printout are translated in instructions on the pattern being printed and the line time used during the printing process. The graphical output of the calibration printout can be linked with the excitation used on the heater element and the heat sink temperature, if necessary supplemented with additional parameters. Using curve-fitting techniques, an analytical expression is fitted through the set of data obtained by printing the calibration printout. Once this analytical relationship is known, for a given requested graphical output, the excitation time can be solved for.

The application claims the benefit of U.S. Provisional Application No. 60/440471 filed Jan. 15, 2003.

### FIELD OF THE INVENTION

The present invention relates to thermal printing or thermography, more specifically to the generation of a mathematical model of the thermal steady state printing characteristics of a thermal printing system, and the use of such model for the driving of a thermal print head.

### TECHNICAL BACKGROUND

Description of the image forming process in thermal printing and related problems.

Thermal imaging or thermography is a recording process wherein images are generated by the use of imagewise-modulated thermal energy. Thermography is concerned with materials which are not photosensitive, but are sensitive to heat or thermosensitive and wherein imagewise applied heat is sufficient to bring about a visible change in a thermosensitive imaging material, by a chemical or a physical process which changes the optical density.

Most of the direct thermographic recording materials are of the chemical type. On heating to a certain conversion temperature, an irreversible chemical reaction takes place and a coloured image is produced.

In direct thermal printing, the heating of the thermographic recording material may be originating from image signals which are converted to electric pulses and then through a driver circuit selectively transferred to a thermal print head. The thermal print head consists of microscopic heat resistor elements, which convert the electrical energy into heat via the Joule effect. The electric pulses thus converted into thermal signals manifest themselves as heat transferred to the surface of the thermographic material, e.g. paper, wherein the chemical reaction resulting in colour development takes place. This principle is described in “Handbook of Imaging Materials” (edited by Arthur S. Diamond—Diamond Research Corporation—Ventura, Calif., printed by Marcel Dekker, Inc., 270 Madison Avenue, New York, ed. 1991, p. 498-499).

A particular interesting direct thermal imaging element uses an organic silver salt in combination with a reducing agent. An image can be obtained with such a material because under influence of heat the silver salt is developed to metallic silver.

A thermal impact printer uses thus heat generated in resistor elements to produce in a certain image forming material, a localised temperature rise at a certain point, which, when driven high enough above a threshold temperature and being kept a certain time above this threshold temperature, gives a visual pixel. In practice, many pixels are being formed in parallel on a same line and then repeated on a line by line basis where the thermographic medium is moved each time over a small position.

A heater element produces during a very short time a heat pulse that is conducted to an emulsion layer with thermographic properties. The thermographic reactions will happen above a fixed temperature T_{threshold}, the latter being a material constant, independent from the ambient temperature. The whole printing process is in fact a feed forward system. Although a precise temperature control is demanded in the thermographic material, no closed loop system can be built that monitors the temperature on the nib surface in order to control the nib excitation online. Now in practice, the problem is a little bit alleviated, as the graphical appearance is determined not by one pixel alone, but by all the pixels together building a filter in the visible light spectrum. When all pixels behave relatively the same with regard to each other, the visual appearance can have some changes in density, but for the rest, the image perception will stay the same for the human eye. Whenever groups of pixels change their properties relatively to other groups of pixels, then a deterioration of the global picture will be perceptible for the human eye. It is therefore important to assess all the parameters that are important in the thermal state of a nib region.

A control algorithm has to determine for every nib the amount of energy that must be dissipated in the resistive element. Depending on the thermal construction of the thermal head, this can be a very simple controller, e.g. all nibs are isolated from each other, giving no visual interaction on the printed media between the several pixels. But in practice, the control algorithm must deal with a variety of real-world problems:

z,1 changing characteristics of the film media, giving different pixel sizes or density for the same nib energy, e.g. some examples:

a different physical thickness of the emulsion layer

a different chemical composition of the image forming components.

[symbol] changing environmental characteristics like temperature and humidity:

a temperature rise of the environment must be taken into account, as the image forming temperature will not rise as it is determined by the chemical composition of the emulsion layer

humidity changes the thermal capacity of the emulsion, producing different temperature rises when applying the same amount of energy.

[symbol] The thermal process itself produces an excessive amount of heat which is not absorbed by the image forming media. This excessive heat is absorbed by a heat sink, but nevertheless, gives rise to temperature gradients internally in the head, giving offset temperatures in the nibs and between the several nibs. E.g. when the image forming process must have an accuracy of 1° C. in the image forming media, an increased offset temperature of 5° C. in the heat generating element must be taken into account when calculating the power to be applied to that element.

[symbol] The heat generating elements are in the ideal case fully thermally isolated from each other. In practice, this is never the case and cross-talk exists between the several nibs. This cross-talk can be localised on several levels:

heat transfer between the several nibs in the thermal head structure itself.

heat transfer in the emulsion and film layer itself.

pixels are not printed one aside the other, but partly do overlap on the print media, mechanically mixing heat from one pixel with the other.

[symbol] The electrical excitation of the nibs is mostly not on an isolated base. This means that not every nib resistor has its own electrical voltage supply which can be driven independent of all the other nibs. In general, some drive signals for driving the nibs are common to each other, this with the purpose of having reduced wiring and drive signals. In general, all nibs can be only switched on or off in the same time-frame. Producing different weighted excitations can only be achieved by dividing the excitation interval in several smaller intervals where for every interval, it can be decided if the individual nib has to be switched on or off, as e.g. described in U.S. Pat. No. 5,786,837. This process of “slicing” has its influence on the thermal image forming process. Example: giving a pattern excitation with the weights (128,0,0,0,0,0,0,0) and (0,64,32,16,8,4,2,1) is mathematically only 1 point different, but the pixel size will be much more different than just 1 point in case of a thick film thermal head, because a ‘0’-no excitation interval produces heat in the nib as well, as described in U.S. Pat. No. 4,360,818 and U.S. Pat. No. 5,702,188). The controller must take this effect into account.

Some aspects of driving thermal print heads are known from EP-1234677.

Thermal Housekeeping in a Print Head.

An illustrative example of a thermal print head 2 is given in FIG. 1. Thermal print heads 2 may have various constructions but mostly adhere to the principle of having electrical nibs or heater elements 4 mounted on a thermal isolating support 6, covered by a protection layer 8. The thermal sensitive material or thermographic material 10 is then pushed against the region of heater elements 4 using a roller system 12. The heater element 4 itself is mounted on a support layer 6. This support layer has several functions:

physical support of the heater element 4 (mechanical purpose)

partly isolating the heater element 4 thermally from the rest of the thermal head

having enough thermal conduction for cooling the heater element 4 to a low temperature necessary for making a new pixel printout.

The dimensioning of the support layer 6 of the thermal heater elements 4 is a difficult job. First of all, enough thermal isolation must be given to the rest of the thermal head 2 in order to attain temperatures in the heater element 4 which are high enough to thermally excite the thermographic material 10. On the other hand, once a pixel has been printed, enough heat must be evacuated from the heater element 4 to be able to restart from a cold nib 4 when some new thermographic material 10 is positioned relative to the nib line. When the heater element 4 is at that moment still too warm and in case no graphical output is wanted, the parasitic heat of other nibs being printed in the neighbourhood, can produce some slight graphical output at that place (known as fog). Evacuation of the parasitic heat in the heater element 4 through the thermographic material 10 itself is mostly not possible because of the often low thermal conductivity of the thermographic material 10 itself and the support roller 12 pushing the material 10 against the nib line, being mostly covered with rubber, having a very limited thermal conductivity. Therefore, the support layer 6 of the heater element 4 must be able to cool it again to some acceptable level.

A Sankey diagram can be constructed showing the flow of the energy applied to the thermal head 2—see FIG. 2. The biggest part of the heater element energy goes to the thermal head support 6 with the heat sink. A part of the energy goes to the thermographic material 10, and another part goes to the support 12 for movement and guidance of the thermographic material 10. Numerical values of the heat flux depend very strongly on the construction of the thermal head 2. In practice, thermal heads 2 with a large heat flow to the heat sink allow to print faster than heads 2 with a limited heat leakage to the heat sink. This is obvious as a good thermal path to the heat sink will cool the heater element 4 faster, giving less recovery time to start printing a new line.

Aspects of Controlling the Nib Temperature With Regard to Heat Sink Temperature.

For precise control of the graphical output, the temperature reached in the thermographic material 10 must be controlled when printing a pixel. Therefore, the amount of energy dissipated in the heater element 4 can be varied according to the initial thermal state of the heater element 4. No measurement is possible of the temperature in the heater element 4, so a feed forward control scheme will be used based upon a control algorithm that is mostly empirical based. Whenever the starting temperature of the heater element 4 is always the same, controlling the amount of energy dissipated in that element 4 will not be that difficult. But in practice, several factors make the initial temperature of a heater element 4 differ:

Latent heat still will be present in the heater element 4 from previous pixel print jobs, as the line time, i.e. the time used to print one line, normally is kept small, giving not enough time to the heater element 4 to cool down.

The temperature of the heat sink is not fixed, but will also rise because of its limited thermal capacity and the limited possibility of transferring the heat to the ambient. This temperature offset in the heat sink will give the same temperature offset in the heater element.

Cross-talk between then nibs also will set an offset to the starting temperature in a heater element 4 when printing a pixel. Normally this is important when printing a single line in several sublines.

U.S. Pat. No. 5,066,961 describes a method for modelling an increased heat sink temperature and means for compensating this increased heat sink temperature by means of a compensation coefficient. A lumped parameter model has been made based upon an equivalent RC-network in the electrical domain. Using analytical calculations, for a known heat sink temperature, the substrate temperature is calculated based upon a mean excitation history of the thermal head.

First, the printhead is brought into a steady state regime by driving the heater elements with a constant duty cycle. For this situation, based upon the thermal model of the printer, the substrate temperature Tₛ is calculated. Then on a single printer line, a pattern is printed with various excitation energies for the heater elements. For the given Tₛ and the measured graphical output D, a function f( ) can be found. A compensation factor is calculated based upon an equal energy delivery to the thermographic printing material.

The above document describes in fact a mathematical model of the thermal head incorporating at the same time the thermal history and the heat sink temperature. But the assumption that a compensation factor can be calculated based upon the energy delivered to the thermographic printing material is not experienced in the investigation that was the subject of this invention.

The method of U.S. Pat. No. 5,066,961 is based on a lumped parameter model. This is only an approximation of the real heat diffusion equation. It is assumed that the temperature in the film material changes exponentially. In reality, the temperature changes as erf(x) functions, which changes faster than exponential on small time scale and slower on large time scales.

U.S. Pat. No. 5,664,893 describes an extra compensation of the thermal model based upon a measurement of the drum supporting the graphical medium. For this, a simple linear compensation is performed on the nib excitation t. Experiments show that such a linear compensation is not fully correct as the graphical formation process is a non-linear process, acting differently on a long term heat already present in the graphical image forming media, opposed to delivered directly during a very short time on a local pixel base.

### SUMMARY OF THE INVENTION

It is an object of the present invention to provide a heat sink temperature compensation algorithm in a thermographic print head.

It is an object of the current invention to make less assumptions than in prior art compensation algorithms, but to try to model the process more accurately based on the real properties of the image forming material and the print head's construction.

This is obtained by the methods and devices of the present invention.

A method is described for building a steady state thermal model for a thermal print head when printing an image on a graphical medium. It is based on a calibration printout on the graphical medium under consideration. The constraints for this calibration printout are translated in instructions on the pattern being printed and the line time used during the printing process. The graphical output of the calibration printout can be linked with the excitation used on the heater element and the heat sink temperature, if necessary supplemented with additional parameters (e.g. thermal medium humidity). Using curve-fitting techniques, such as for example, but not limited to, regression using polynomials or splines, or neural networks, an analytical expression is fitted through the set of data obtained by printing the calibration printout. The form of this analytical function has to be selected in relationship to the data, but in most cases, second-degree polynomials will give an accurate result. Once this analytical relationship is known, for a given requested graphical output, the excitation time can be solved for.

A thermal head is basically a construction mounted on a cooling plate. The purpose of the cooling plate is to remove the heat generated in the nibs. Only a small fraction of the heat generated in the nib is used for the image forming process. All the rest must be removed by the heat sink. It is preferred to bring a nib to a low initial starting temperature before a new pixel is printed. When a nib stays too hot, the cross-talk heat of the neighbouring nibs might give a graphical output on the thermal sensitive material, although no electrical excitation has been given to this nib.

In general, the whole thermal head system, comprising the image forming material and the means for pressing the image forming material against the nib structure, constitutes a very complex three-dimensional thermal system. In this system, the only constants are the image forming parameters of the thermal sensitive material. The thermal characteristics of the image forming materials are constant and regardless of the thermal state the thermal head possesses, the final temperature reached in the image formal material must be the same. Practical tolerances are only a few ° C.

In general, a controller must cope with the real thermal state the thermal head is in. To accomplish this, in practice, thermal sensors are mounted at several places in the thermal head. From the output of these thermal sensors, a reference temperature can be calculated for every nib in the head. This reference temperature is most often the temperature of the heat sink close to the considered nibs. It is assumed for the invention that it is known for a given set of sensor values (e.g. linear interpolation or mathematical observer).

The present invention relates to a method for establishing a mathematical model relating the graphical output dₙ of a heater element n, the graphical output being e.g. pixel size or pixel density, in function of the heat sink temperature T_{ref}ⁿ of every heater element and the used steady state amounts of heat energy Eₙ, being applied to the heater element n. The index n refers to the nib number, n=0, . . . ,N_{nibs}−1, N_{nibs} being the number of nibs in the thermal print head. This function can be written as: dₙ=fₙ(T_{ref}ⁿ,Eₙ) and gives a relationship between the heat sink reference temperature T_{ref}ⁿ, the energy Eₙ applied to nib n and the resulting graphical output dₙ at nib n. If necessary, other parameters can be added to the argument list of this function as e.g., but not limited thereto, humidity of the thermal sensitive image forming material.

The nature of fₙ is principally unknown and is in most cases a non linear function because the image forming process itself is strongly dependent in a non linear way on the value of T_{ref}ⁿ and Eₙ and on the construction of the thermal head, making fₙ different for every nib n. When a uniform construction of the thermal head is present, fₙ can be identical for all nibs, resulting in a single function f. Although fₙ can be different for every nib n, in practice, fₙ will not differ very much from fₙ₊₁, as both share a common thermal structure that will vary only slowly along the length of the print head.

The method of the present invention comprises making a reference printout on the considered thermal image forming material (calibration print out). The pattern printed preferably is chosen delicately:

Preferably no cross talk influences the pixels printed, otherwise, a mixing of several parameters in this function finding process is obtained, making it only terribly complicated and prone to errors. During the process of finding fₙ, preferably only the arguments and outputs of fₙ should change, and no other parameters should be involved.

The reference printout is divided in zones along the scan direction of the thermal print head (or thermal media movement direction), for example on a horizontal base. Every zone comprises a plurality of printed pixel lines, the number of lines being large enough so that a macro density measurement is possible in such a zone. The number of lines is preferably not too large, so that the good approximation can be made that the reference temperatures T_{ref}ⁿ will not change. In real time, when printing this zone, the sensor outputs should preferably be recorded, allowing an on the line or a priori calculation of the reference temperatures T_{ref}ⁿ. After the reference printout is made, for every zone, the reference temperature T_{ref}ⁿ is known.

For every zone, a constant or steady state amount of heat energy Eₙ or a constant excitation time tₙ is used.

When other parameters are involved into the process, they also preferably are recorded for every zone.

The reference printout preferably consists of several zones covering different values of Eₙ or tₙ and if necessary being repeated multiple time, so that you will get a span of different values of Eₙ or tₙ and different values of T_{ref}ⁿ. In practice, to have different values of heat sink temperature T_{ref}ⁿ (up to the usable working boundaries), the reference printout can be very long.

The pattern in every zone is preferably of a kind also that an easy extraction of the graphical evaluation function dₙ is simple and robust.

The printing process is preferably done with a monotone slicer, giving no discontinuous jumps in the graphical output when changing continuously the excitation weight. (for the construction of a monotone slicer, see EP-1234677).

Once the experiment or the printing of the reference printout is finished, a large amount of data pairs describing the function fₙ have been obtained. A graph can be made with in the x-axis the zone number and in the y-axis the graphical evaluation parameter dₙ. When Eₙ or tₙ has been chosen to be a continuous function of the zone number, continuous curves of dₙ will be found. In most cases, this will be a rather linear curve (especially when a linear slicer algorithm has been used). A polynomial function can then be picked which will contain some unknown constants, but which is very likely to give a correct approximation of the fₙ function. An example function:

d=(a₂T_{ref}²+a₁T_{ref}+a₀)t²+(b₂T_{ref}²+b₁T_{ref}+b₀)t+(c₂T_{ref}²+c₁T_{ref}+c₀)

The constants are unknown but can easily be extracted using e.g. a multi-parameter fitting process on the data obtained from the previous process.

The result can be examined e.g. graphically by comparing the fitted curve with the measurement data. When no fit is attained, additional powers of T or E have to be added. But the nature of the thermal system is such that in most cases a very good fit is found between the model and the measurement data. Once the function f or the fₙ's are known, a mathematical model is readily available for making temperature compensation when printing on line. T_{ref} is known at a particular time for every nib. Using the above equation and given requested pixel size d, E or t can be calculated for by a simple root finding method. In this way, the invention gives a method of developing a correct heat sink compensation algorithm. If necessary, other dependent parameters having influence on the image formation, can be added to this method.

The present invention provides a method for generating a mathematical model of thermal steady state printing characteristics of a thermal printing system using a computing device, the thermal printing system comprising a thermal printer having a thermal head incorporating a plurality of energisable heater elements and a heat sink, and a thermographic material. The method comprises:

making a reference printout on the thermographic material, said reference printout consisting of several printed regions with each of the several printed regions being printed with a different steady state amount of heat energy (Eₙ) delivered to the heater elements,

determining a measure of the graphical output (dₙ) in function of at least a parameter relating to the heat sink temperature for each of the several printed regions measured in a zone of each region where the graphical output (dₙ) was printed in a thermal steady state,

establishing the mathematical model by determining a best fit relationship between the measures of the graphical output (dₙ) in function of at least the parameter related to the heat sink temperature and the steady state amounts of heat energy (Eₙ).

The present invention also provides a method for driving a thermal print head of a thermal printing system comprising a thermal printer having the thermal print head incorporating a plurality of energisable heater elements and a heat sink, and a thermographic material. The method comprises:

in a first mode establishing a mathematical model by:

making a reference printout on the thermographic material, said reference printout consisting of several printed regions with each of the several printed regions being printed with a different constant amount of heat energy (Eₙ) delivered to the heater elements,

determining a measure of the graphical output (dₙ) in function of at least a parameter related to the heat sink temperature for each of the several printed regions measured in a zone of each region where the graphical output (dₙ) was printed in a thermal steady state,

establishing the mathematical model by determining a best fit relationship between the measures of the graphical output (dₙ) and the constant amounts of heat energy, and,

in a second mode:

determining a heat energy to be supplied to at least one energisable heater element in accordance with the mathematical model for printing of an image on a thermographic material using a thermal printing system comprising a thermal printer having a thermal print head incorporating a plurality of energisable heater elements and a heat sink, and a current value of the parameter related to the heat sink temperature.

In a method according to the present invention, the thermal head may be a line type thermal head.

In a method according to the present invention, the thermographic material may comprise a support and a thermosensitive layer.

The energisable heater elements may be mounted on a multi-layered support structure with known thermal properties for the several layers (kᵢ,cᵢ,ρᵢ).

The heat energy may be represented by a given equivalent time (t_{exc}) used for powering the heater element with an equivalent constant power (P₀), Eₙ=t_{exc}*P₀.

A method according to the present invention may furthermore comprise, while making the reference printout, logging of parameters (Pⱼ) that are determinative to the graphical output (dₙ). The parameters (Pᵢ) may be measurable and identifiable parameters that directly affect the graphical output (dₙ) produced by the thermal head. The parameters may be linked to the location of the considered heater element and may be different for heater elements at a different position on the thermal head.

A method according to the present invention may comprise establishing a table of data comprising the steady state graphical output function (dₙ), and the used energy (Eₙ or t_{exc}), giving an implicit relationship between the graphical output function (dₙ) and its controlling parameters (Eₙ or t_{exc}). The table (T) may furthermore comprise the parameters (Pₙ) that are determinative to the graphical output (dₙ). The best fit relationship may be a parametrisable function (f( )), being defined by a set of unknown coefficients (a,b,c,d, . . . ) found using a curve fitting process on the table (T). The energisable heater element may still produce some heat when not explicitly being excited by an active pulse, and the equivalent time (t_{exc}) may be corrected so as to give an identical graphical output on the image forming material.

A line time (tₗᵢₙₑ) used for printing the graphical output (dₙ) of said reference printout may be chosen so as to have a small transient phase in the graphical output (dₙ) when changing the energy level (Eₙ) from one region to the other. The line time (tₗᵢₙₑ) may have a reference line time (tₗᵢₙₑ^{ref}) that is larger than a critical line time (tₗᵢₙₑ^{crit}).

A printing pattern of said reference printout may be selected so that the pixels being printed do not interact with each other.

The printing of the regions with a constant amount of heater energy (Eₙ) is repeated several times.

The number of lines a printed region consists of may be taken large enough to bridge the first lines showing a transient graphical output, but small enough to be able to assign the graphical output to a well determined value of the parameters (Pⱼ).

The critical line time (tₗᵢₙₑ^{crit}) may be assessed based on the thermal properties of the first supporting layer of the heater element. The first supporting layer of the heater element may have a diffusion time constant (t_{d}) with the same order of magnitude as the normal line time. The diffusion time constant (t_{d}) of the first supporting layer of the heater element may be defined as τ_{d}=\sqrt{πat}, a being the thermal diffusion constant of the material,

$$a = \frac{{k}_{i}}{{ρ}_{i} {c}_{i}} .$$

The transient behaviour of a series of offset temperatures at the beginning of each line as a consequence of the first supporting layer accumulating heat, may be modelled by the theoretical series

$$\frac{{T}_{LineN}}{{T}_{max}} = {\sum }_{j = 1}^{N} \frac{{\sum }_{i = 0}^{∞} \frac{1}{{( 2 i + 1 )}^{2}} \cdot [ {ⅇ}^{- {( 2 ⅈ + 1 )}^{2} ( j \cdot {τ}_{line} - {τ}_{exc} )} - {e}^{- {( 2 ⅈ + 1 )}^{2} j \cdot {τ}_{line}} ]}{{\sum }_{i = 0}^{∞} \frac{1}{{( 2 i + 1 )}^{2}} \cdot [ 1 - {ⅇ}^{- {( 2 ⅈ + 1 )}^{2} {τ}_{exc}} ]} ,$$

with τ_{exc} and τₗᵢₙₑ dimensionless parameters related to the supporting layer,

$${τ}_{exc} = \frac{a {π}^{2}}{4 {d}_{l}^{2}} {t}_{exc} \text{and} {τ}_{line} = \frac{a {π}^{2}}{4 {d}_{l}^{2}} {t}_{line} , {d}_{i}$$

being the thickness of the supporting layer, the time t_{exc} being the equivalent excitation time. An appropriate choice of the line time (tₗᵢₙₑ=tₗᵢₙₑ^{crit}) may be taken so as to make the said series convergent within an acceptable number of lines and with an acceptable allowed error in order to keep the printing region small enough and have an accurate measurement of the steady state graphical output for that region.

The transient behaviour of the graphical output (dₙ) because of a change of heater element energy (ΔEᵢ) when stepping from one region to the other may be measured, and an appropriate value of the line time (tₗᵢₙₑ^{ref}) may be chosen in order to keep the transient region limited to a small number of lines so as not to make the transient behaviour interfere with the graphical characterisation of that region.

The best fit relationship may be given by dᵢ=f(t_{exc}) where t_{exc} is an excitation time of a heater element and this relationship is corrected when using the printing system at a different line time by adding an offset Δt_{exc} to t_{exc}, Δt_{exc} being found as the value that full-fills the equation

$${\sum }_{i = 0}^{∞} \frac{1}{{( 2 i + 1 )}^{2}} \cdot [ {ⅇ}^{- {( 2 ⅈ + 1 )}^{2} ( {τ}_{line}^{ref} - {τ}_{exc} )} - {ⅇ}^{- {( 2 ⅈ + 1 )}^{2} {τ}_{line}^{ref}} ] = {\sum }_{i = 0}^{∞} \frac{1}{{( 2 i + 1 )}^{2}} \cdot [ {ⅇ}^{- {( 2 ⅈ + 1 )}^{2} ( {τ}_{line} - ( {τ}_{exc} + Δ {τ}_{exc} ) )} - {ⅇ}^{- {( 2 ⅈ + 1 )}^{2} {τ}_{line}} ] .$$

The offset Δt_{exc} may be determined by experimental means by changing the excitation time by an amount of Δt_{exc} until the graphical output is identical to the printout at a line time tₗᵢₙₑ^{ref}.

The graphical output (dₙ) may be a pixel with a certain colour spectral density in the centre of the pixel and/or a pixel with a certain size defined by a perimeter having a given colour spectral density, to be reproduced on said thermographic material.

In the method according to the present invention, the energisable heater elements may be any of:

electrically excited heater elements based on the Joule effect, directly (conductive) or indirectly (capacitive, inductive, RF) supplied from a voltage source

heater elements based on a light or IR to heat conversion process

heater elements based on exothermal chemical, biological or pyrotechnic controllable reactions

The energisable heater elements may be excitable by multiple energy pulses N, N being larger or equal to 1, during a single line time, these multiple pulses being converted to an equivalent excitation time t_{exc} given as a single energy pulse and giving an identical graphical output (dₙ) on the thermographic material.

The present invention also provides a control unit for use with a thermal printer for printing an image onto a thermographic material, the thermal printer having a thermal head incorporating a plurality of energisable heater elements. The control unit is adapted to control the driving of the thermal printer so as to make a reference printout on the thermographic material, said reference printout consisting of several printed regions, the driving of the thermal printer being such that each of the several printed regions is printed with a different constant amount of heat energy delivered to the heater elements. The control unit is furthermore adapted to determine a measure of the graphical output for each of the several printed regions measured in a zone of each region where the graphical output was printed in a thermal state. And the control unit is furthermore adapted to establish a mathematical model of thermal steady state printing characteristics by determining a best fit relationship between the measures of the graphical output and the constant amounts of heat energy. The control unit may furthermore be adapted for determining a heat energy to be supplied to at least one energisable heater element in accordance with the mathematical model.

The present invention also provides a thermal print head provided with a control unit according to the present invention.

The present invention furthermore provides a computer program product for executing any of the methods of the present invention when executed on a computing device associated with a thermal print head.

The present invention also provides a machine readable data storage device storing the computer program product of the present invention.

These and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 Illustrative example of a thermal printing system showing the area with the heater elements and the thermographic material pushed against this area by a rubber roller.

FIG. 2 Sankey diagram of the heat balance in a thermal head, starting from the heat energy generated in the heater element (heat flux values are only illustrative).

FIG. 3 Schematic defining the construction of a thermal model for a thermal print head that can deal with a non-linear relationship regarding the graphical output process.

FIG. 4 Cross-section of a typical thermal head structure. The thermal sensitive material and the rubber guiding support have also been added.

FIG. 5 Cross-section of the model used for deriving an equation for the temperature distribution in the material.

FIG. 6 Illustration of the fact that a heater element excitation with a power Q₀ can be seen as a superposition of two infinite power excitations, starting at a different time and having a different sign.

FIG. 7 Calculated temperature in the heater element due to the thermal resistance of a 1 mm ceramic layer at increasing line times relative to the excitation time.

FIG. 8 Example of the limited convergence rate of Equation 39 where only the first terms in the summation have been used for calculating the ratio Tₗᵢₙₑ/Tₘₐₓ.

FIG. 9 Transient increase of the heater element temperature with the line number printed due to the latent heat present from the previous lines. Line time equals 2, 4, 8 and 16 times the nib excitation time.

FIG. 10 Transient behaviour of the latent temperature in the heater element region for different line times (Tₗᵢₙₑ/T_{exc}=2,4,8 and 16).

FIG. 11 Experimental results showing the increase of line thickness for various line times. Remark that at line 1, the lines start at a different thickness due to a temperature offset in the thermal head.

FIG. 12 Example of the several excitation values used for driving the heater elements.

FIG. 13 Recorded heat sink temperature recorded for every considered different value of t_{exc}. Two printouts have been made, one after the other, giving an explanation for the temperature dip.

FIG. 14 Close up of the line pattern being printed for obtaining the relational expression d=f(t_{exc},T_{HS}, . . . ); the dot pitch equals 4 times the printer resolution τ.

FIG. 15 Picture of the line pattern being printed for characterising the total graphical process and establishing a relationship with T_{HS} and t_{exc}. For every region, t_{exc} has been kept constant and a mean value of T_{HS} has been recorded.

FIG. 16 Measured pixel size d for varying values of t_{exc} and rising heat sink temperature T_{HS}. The results of 2 plots have been appended, showing clearly the influence of T_{HS} rising steadily during the experiment (see also FIG. 13).

FIG. 17 Points calculated using the expression from Equation 43 are plotted on the original measured d-values, showing a good approximation with the original data.

FIG. 18 Corrected excitation time for varying values of the line time in order to get the same steady state graphical output relative to a 100 ms line time printout.

FIG. 19 Temperature distribution in an infinite material when applying a fixed temperature at x=0 at t=0. For three instances of time, the temperature distribution is given in the material. The asymptotic straight line intersects the x-axis at \sqrt{πat}.

FIG. 20 shows some basic functions of a direct thermal printer.

FIG. 21 shows a control circuitry in a thermal print head comprising resistive heater elements.

FIG. 22 illustrates a print pattern used for the calibration printout according to the present invention, the print pattern consisting of horizontal zones, each zone using a constant value for the excitation energy Eᵢ or excitation time tᵢ.

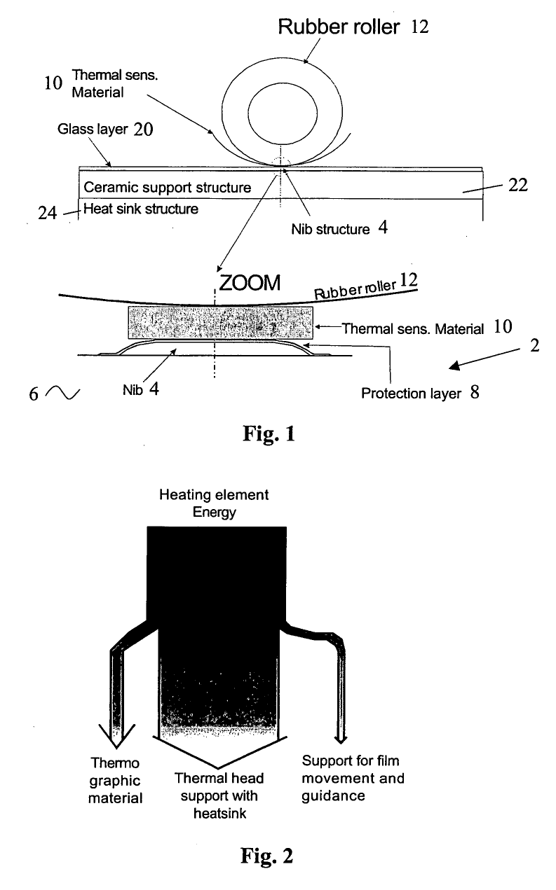

### DETAILED DESCRIPTION OF THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Explanation of Terms

For the sake of clarity, the meaning of some specific terms applying to the specification and to the claims are explained before use.

An “original” is any hardcopy or softcopy containing information as an image in the form of variations in optical density, transmission, or opacity. Each original is composed of a number of picture elements, so-called “pixels”. Further, in the present description, the terms “pixel” and “pixel area” are regarded as equivalent.

Furthermore, according to the present invention, the term pixel may relate to an input image (known as original) as well as to an output image (in softcopy or in hardcopy, e.g. known as print).

The term “thermographic material” (being a thermographic recording material, hereinafter indicated by symbol m) comprises both a thermosensitive imaging material and a photothermographic imaging material (being a photosensitive thermally developable photographic material).

For the purposes of the present specification, a “thermographic imaging element” le is a part of a thermographic material m.

By analogy, a thermographic imaging element le, comprises both a (direct or indirect) thermal imaging element and a photothermographic imaging element. In the present application the term thermographic imaging element le will mostly be shortened to the term imaging element.

By the term “heater material” (hereinafter indicated by symbol hm) is meant a layer of material which is electrically conductive so that heat is generated when it is activated by an electrical power supply.

In the present specification, a heater element Hₙ is a part of the heater material hm.

A “heater element Hₙ” (sometimes also indicated as “nib”) being a part of the heater material hm is conventionally a rectangular or square portion defined by the geometry of suitable electrodes.

A “platen” comprises any means for firmly pushing a thermographic material against a heater material, e.g. a drum or a roller.

According to the present specification, a heater element is also part of a “thermal printing system”, which system further comprises a power supply, a data capture unit, a processor, a switching matrix, leads, etc.

““A “heat diffusion process” is a process of transfer of thermal energy (by diffusion) in solid materials.

A “heat diffusion partial differential equation PDE” is a partial differential equation describing a heat diffusion process in a solid material.

A “specific heat production qⁿ” is a volumetric specific thermal power generation in the confined bulk of the thermographic material [W/m³].

A “specific mass ρ” is a physical property of a material and means mass per volumetric unit [kg/m³].

A specific heat c means a coefficient c describing a thermal energy per unit of mass and per unit of temperature in a solid material at a temperature T [J/kg.K]

A “thermal conductivity k” is a coefficient describing the ability of a solid material to conduct heat, as defined by Fourrier's law

$$q = - k \cdot \frac{ⅆ T}{ⅆ x} ,$$

k is expressed e.g. in [W/(m.K)]. An extension from k to anisotropic materials is possible by replacing k by a tensor \overline{k}. In that case \overline{q}=−\overline{k}grad(T) holds.

In the present application, a “pixel output d” or a “graphical output d” or shortly an “output d” comprises a quantification of a pixel printed on a recording material, said quantification possibly relating to characteristics as density, size, etc. The pixel output of nib n is denoted dₙ.

The term “controllability” of a thermal printing system denotes the ability to precisely control the output of a pixel, independent from the position of the pixel, the presence of pixel neighbours, the environmental conditions and the past thermal history of the printing process.

The term “compensation” denotes the process of determining the exact amount of thermal energy that has to be delivered to a heater element in order to achieve a controlled graphical output.

It is known, and put to intensive commercial use (e.g. Drystar™, of Agfa-Gevaert), to prepare both black-and-white and coloured half-tone images by the use of a thermal printing head, a heat-sensitive material (in case of so-called one-sheet thermal printing) or a combination of a heat-sensitive donor material and a receiving (or acceptor) material (in case of so-called two-sheet thermal printing), and a transport device which moves the receiving material or the donor-acceptor combination relative to the thermal printing head. Hereinafter, a working method according to the present invention will be explained in full depth.

### DETAILED DESCRIPTION

The present invention concentrates merely on the effect of increased heat sink temperature in a thermographic print head. In practice, the printing process will be controlled based upon a reference temperature T_{ref} being present in the heat sink. A deviation of the heat sink temperature relative to this reference temperate T_{ref} can easily be measured by installing temperature sensors in the heat sink. If x represents a co-ordinate running along the long axis of a heat sink, then T_{HS}(x) represents the deviation of the local heat sink temperature relative to the reference temperature T_{ref}:

T_{HS}(x)=T_{measured}(x)−T_{ref}, Equation 1:

T_{measured}(x) being the online recorded temperature in the several temperature sensors along the heat sink of the print head.

Whenever T_{HS}(x) is known, various control strategies are being used to compensate for this elevated reference temperature that can be found in the heater element at position x.

The substrate temperature can be found by computational means, and the link with the graphical output is made based on the following equation:

d=f(T_{HS},t_{exc}), Equation 2:

with:

d a parameter describing the graphical output,

T_{HS} the heat sink temperature,

t_{exc} a parameter representative for the level of heater element excitation, e.g. the excitation time.

The function d=f(T_{HS},t_{exc}) is determined by making experimental printouts. First, the printhead is brought into a steady state regime by driving the heater elements with a constant duty cycle. For this situation, based upon the thermal model of the printer, the heat sink temperature T_{HS} is being calculated. Then on a single printer line, a pattern is printed with various excitation energies for the heater elements. For the given T_{HS} and the measured graphical output d, a function f( ) can be found.

Experiments show that latent heat coming from the heat sink does not always have the same property of generating graphical output as the heat generated in the heater element. In fact, heat already present in the thermal head, and therefore also partly in the thermal sensitive emulsion, tends to increase the graphical formation process in a non-linear sense.

A Thermal Model for the Print Head.

Most thermal models for print heads are based on a lumped parameter approach. These models are only an approximation as the underlying differential equations are different. The resistors in a lumped parameter model represent the steady state thermal resistance of a constructional material piece in the thermal print head (TPH). The capacitor represents the thermal capacity of the constructional material.

For the moment, the diffusion equation is used, and therefore the lumped parameter model is not used.

An aim of the present invention is not to build a “total mathematical model” for a TPH. Much depends on the practical construction and therefore, a priori modelling is not possible. But the idea is to give a basic frame that will compensate for a random heat sink temperature that is valid for a particular thermographic material, used during the calibration process. Upon this model, corrections can be made for the particular head regarding cross talk and latent heat from one line to the other.

Control Strategy.

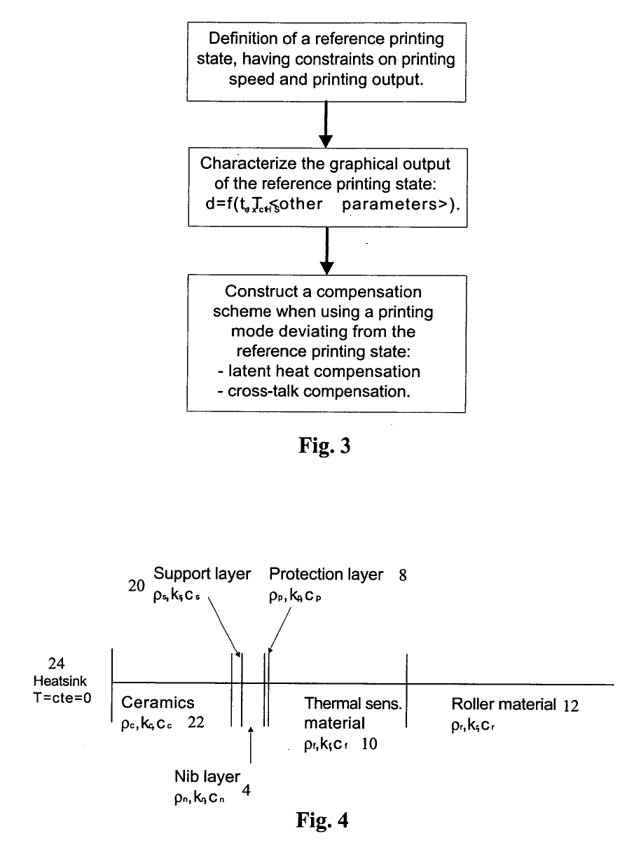

A thermal model for the TPH is built based upon the schematic depicted in FIG. 3. The idea is to define a reference printing state for the thermal printer that will be characterised towards the graphical output process. An explicit relationship will be defined between the graphical output d (can be for example density information or pixel size) and the basic printing parameters, being heat sink temperature T_{HS} and nib excitation time t_{exc}. Once this relationship is known, when printing in the reference print mode, for a given value of T_{HS} (measured using sensors), the excitation time t_{exc} can be calculated for the nib, as to give an a priori described graphical output d.

The concept of a reference printing state is very important, as it contains many constraints, both on thermal state of the printer as on the graphical output it can produce. A detailed description will be given later on. In practice, it is not possible to print random pictures with this reference printing state, as it will violate some of the constraints as defined in the reference printing state. Normally, any deviation from the reference printing state will violate the d=f(T_{HS},t_{exc}) relationship. Therefore, compensation must be performed for every deviation from the reference printing state. An aim of this invention is not to define every compensation scheme for every possible deviation from the defined reference printing scheme, as this requires an exact layout of the thermal head construction and is also described in numerous other patent applications.

Detailed Description of the Reference Printing State.

Basic Principle of the Reference Printing State.

The basic concept is to define a printing state, allowing a precise characterisation of the graphical image forming process:

d=f(T_{HS},t_{exc},<other parameters>) Equation 3:

For being able to precisely characterise the image forming process, it is preferred to exclude any influencing or disturbing effects from the printing device itself:

any accumulation of latent heat in a nib from the previous pixel print, will increase the nib temperature and therefore influences the T_{HS} with an unknown amount.

when cross-talk exists between the nibs, using a printing pattern that is cross-talk sensitive again will change the nib excitation times t_{exc} with an unknown amount.

Therefore, a theoretical definition of the reference printing state could be:

wait an infinite amount of time between the process of printing a pixel as to allow the nib temperature to cool down again to the reference heat sink temperature T_{HS}.

pixels printed are at an infinite distance from each other, excluding any cross-talk effects.

the whole heat sink preferably has a homogeneous temperature, meaning that heater elements should be excited all over the thermal head, giving a good symmetrical heating of the heat sink. The definition of T_{HS} is more obvious as a mean value of the heat sink temperature can be taken all along the thermal head.

These constraints will impose the exact knowledge of the T_{HS} and the t_{exc} values. For a produced graphical output, for every pixel printed, the corresponding value of T_{HS}, t_{exc} and if necessary, other determining parameters (e.g. temperature of the image forming layer, humidity of the image forming layer) can be tabulated.

The above definition of the reference printing state is not very practical, as it will take a very long time to make a graphical output. Therefore, this definition has to be relaxed to a more practical formulation of the reference printing state. This is done based on the method used for the graphical characterisation. The basic idea is to be able to establish an explicit known relation between the graphical output and the printing parameters (Equation 3). The parameters t_{exc} and T_{HS} must be known with an acceptable accuracy. In practice, it is not necessary to wait an infinite amount of time between printing a pixel in a nib. Heat will spread rapidly in the thermal head and within a reasonable time, the latent heat in the nib will be spread to the other parts of the head, giving an acceptable error on the T_{HS} value used when printing the next line. In that case, it can be assumed with a negligible error toward the graphical formation process, that the pixel has been printed with a T_{HS} value, as measured by the several sensors. The time tₗᵢₙₑ that must be waited between the printing of the pixels is defined in the next paragraph.

The statement from the previously defined reference printing state that pixels are infinitely apart from each other can be relaxed in practice quite a lot. Mostly, only neighbouring nibs will influence each other directly by introducing a small increase of the t_{exc} value. Practical values depend strongly on the construction of the thermal head and the way the heater elements are being excited, but it is always possible to define a printing pattern that will be free from cross talk. A practical example is a line pattern with the lines spaced enough from each other so that printing a single line, or a line together with its neighbouring lines, has no effect to the density or width of the line. In that case, no cross talk is present between the actual nibs used for printing the pattern, implying that for the corresponding graphical output, the used t_{exc} value is known exactly.

Before giving a practical definition of the reference printing state, an acceptable value is deduced for the line time tₗᵢₙₑ based upon the practical construction of the thermal head.

Assessment of a Line Time tₗᵢₙₑ That Gives a Controlled Error on the T_{HS} Value in the Nib Itself.

The construction of a thermal head is mostly based on a system consisting of different layers of material. In the present analysis, the thermal structure of the head 2 is regarded as a one-dimensional structure—see FIG. 4. As shown in FIG. 4, the layers of the thermal head comprise a support layer 20, such as e.g. a glass layer, a support structure 22, such as e.g. a ceramics layer, and a heat sink structure 24.

The thermal conductivity of the thermal sensitive material 10 is in most applications very low. Therefore, the heat flowing into the thermal sensitive material 10 is neglected, assuming that all the heat must be transported to the heat sink 24. This analysis will give then an upper boundary to the latent heat sustained in the nib region. Also, the 3-dimensional character of the thermal head 2 always will give lower values of the nib temperature as there will be losses of heat in the other spatial directions.

Whenever there are several layers of material, there always will be one layer that shows the largest thermal resistance to the flow of heat. This means that it's diffusion time will be much larger with regard to the other structures. The next paragraph gives some more background information about the diffusion depth d_{d} and the diffusion time t_{d}.

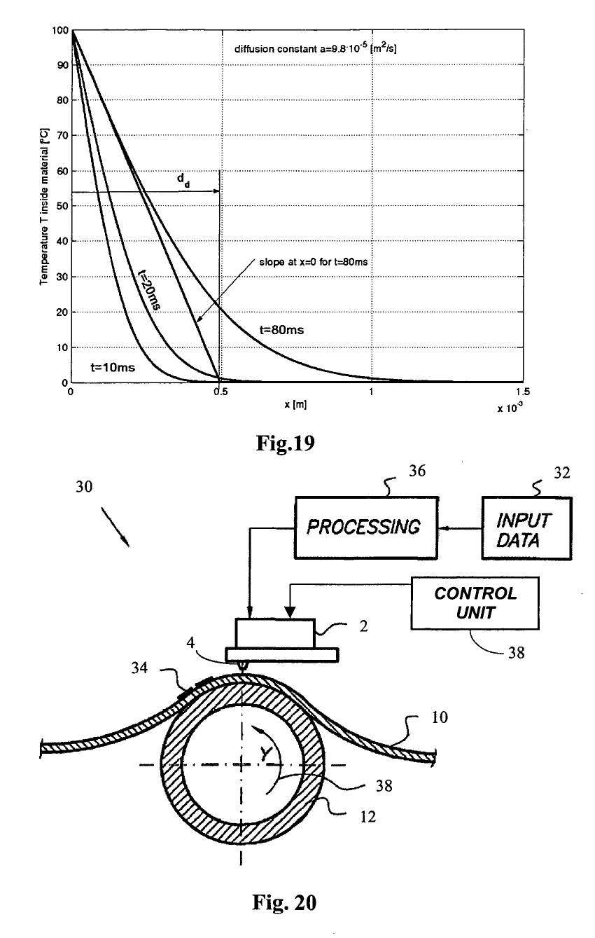

A material is considered, with thermal properties ρ, k, c, having an initial homogeneous temperature equal to zero. The material boundary is lying at x=0 and extends infinitely in the positive x-direction—see FIG. 19. At time t=0, a temperature offset T₀ is applied at the left boundary of the material (x=0). Slowly, the heat will penetrate into the material and at t=∞, the material will also have a homogeneous temperature equal to T₀.

The boundary value problem is described by the one dimensional heat diffusion equation:

$$\text{Equation 4:}$$

$$\frac{\partial T ( x , t )}{\partial t} = \frac{k}{ρ c} \frac{{\partial }^{2} T ( x , t )}{\partial {x}^{2}} = a \frac{{\partial }^{2} T ( x , t )}{\partial {x}^{2}} .$$

In this special case, a simple analytic solution exists, as known from “Einführung in die Lehre von der Wärmeübertragung”,VDI-Wärmeatlas, 3. Auflage 1977, pp. Ed3.:

$$\text{Equation 5:}$$

$$T ( x , t ) = {T}_{0} [ 1 - erf ( \frac{x}{2 \sqrt{a t}} ) ] .$$

The heat flux flowing into the material at x=0 is given by:

$${{\text{Equation 6:} \\ q ( t ) = - k \frac{\partial T ( x , t )}{\partial x} \vert}_{x = 0} = k {T}_{0} \frac{2}{\sqrt{π}} \cdot \frac{1}{2 \sqrt{a t}} \cdot {ⅇ}^{- \frac{{x}^{2}}{4 a t}} \vert}_{x = 0} = {T}_{0} \frac{k}{\sqrt{π a t}} .$$

For a certain instance of time t, the half space can be replaced by the same material but with limited thickness d_{d}, giving identical heat flux at x=0 considering a steady state heat flow into the material. This corresponds to a linear temperature profile in the material going from T₀ to 0 at x=d_{d}. For this fictitious situation, the heat flux will equal:

$$\text{Equation 7:}$$

$$q ( t ) = k \frac{{T}_{0}}{{d}_{d}} .$$

Setting Equation 6 equal to Equation 7, gives an expression for the diffusion depth d_{d}, being representative for the depth of the heat penetration into the material:

$$\text{Equation 8:}$$

$${d}_{d} = \sqrt{π a t} .$$

Alternatively, an expression for time can be derived:

$$\text{Equation 9:}$$

$${t}_{d} = \frac{{d}_{d}^{2}}{π a} ,$$

being the time necessary for the heat to penetrate to that depth.

When x equals the diffusion depth d_{d}, the real temperature at that spot is given by:

$$\text{Equation 10:}$$

$$T ( d ) = {T}_{0} [ 1 - erf ( \frac{\sqrt{π a t}}{2 \sqrt{a t}} ) ] = {T}_{0} [ 1 - erf ( \frac{\sqrt{π}}{2} ) ] = 0.375 {T}_{0} .$$

This will be illustrated with a fictitious example. A thick film head 2 with a 1 mm ceramic layer 22 lying on an Aluminium heat sink 24 is considered. On top of the ceramic layer 22, a layer 20 of 50 μm of glass is deposited, being a carrier for the heat generating material 4. The diffusion time is calculated (Equation 9) for the ceramic 22, the glass carrier 20 and the heatsink 24 (Table 1). For the latter, the distance from the nibline to a temperature sensor is taken.

TABLE 1
Calculated diffusion times for two
material layers in a thermal head.

| | ρ | k | | | Thickness | |
|---|---|---|---|---|---|---|
| Material | [kg/m³] | [W/mK] | c [J/kg] | a [m²/s] | [μm] | t_{d} [ms] |
| Ceramic | 4000 | 24 | 800 | 7.50e−6 | 1000 | 42.4 |
| Glass | 3500 | 1.1 | 720 | 4.37e−7 | 50 | 1.82 |
| Aluminium | 2700 | 235 | 885 | 98.3e−6 | 30000 | 6311 |

For this print head, the line time used was larger than 15 ms. This means that the temperature behaviour in the glass layer 20 carrying the heater element 4 is not that important as the considered time frame is several times the diffusion time of the glass layer 20. The ceramic layer 22 on the contrary has a rather large diffusion time (42.4 ms) and is of the same order of magnitude as the normal working line time. This means that when starting a new pixel print on the next line, quite some latent heat will be present in the nib 4 due to the limited heat conduction in the ceramic layer 22. It would be very advantageous now in this discussion to have an expression for the temperature still present in the nib 4 at the end of the line time tₗᵢₙₑ.

Deduction of a General Equation for the Temperature Distribution at Constant Heater Element Excitation.

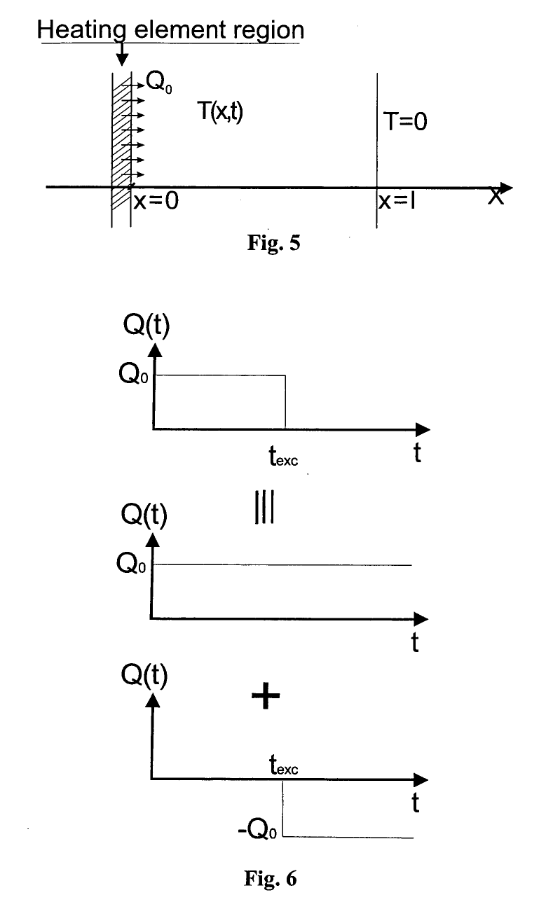

It is assumed that the heat produced in the heater element has only very limited losses to the thermographic material itself. In practice, this is not the case but the mathematical results found will then always give the worst case situation. It also is assumed that the materials around the heater element itself have limited heat capacitance and heat diffusion times which are small compared to the excitation time of the heater element itself. In that case, the model of FIG. 5 can be used where the region of the heater element is modelled by a heat generator having a power Q(t)=Q₀[J/s]. It is tried to find an expression for the transient temperature distribution for a layer of material ranging from x=0 to x=1 with the material properties ρ, k and c. In the example given above, this would be the ceramic layer 22. At x=1, it is assumed that the temperature equals 0 in the calculation (heat sink region). In most cases, the heat sink also exhibits small diffusion times or by means of temperature sensors, the temperature can be measured near to the ceramic surface.

This boundary value problem is controlled by the heat diffusion equation:

$$\text{Equation 11:}$$

$$\frac{\partial T ( x , t )}{\partial t} = \frac{ρ c}{k} \frac{{\partial }^{2} T ( x , t )}{\partial {x}^{2}} = a \frac{{\partial }^{2} T ( x , t )}{\partial {x}^{2}} .$$

There is looked for a solution using the method of separation of variables, as explained in many textbooks, such as for example “Randwerteprobleme und andere Anwendungsgebiete der höheren Analysis für Physiker, Mathematiker und Ingenieure”, F. Schwank, Kassel, B. G. Teubner Verlagsgesellschaft Leipzig, 1951, pp. 192. In a first step, it is assumed that Q(t) is a constant function, equal to Q₀. Later on, Q(t) will be taken a time limited excitation pulse with length t_{Q}.

The boundary conditions of this problem can then be formulated as:

$$\text{Equation 12:}$$

$$\{ \begin{matrix}{- k \frac{\partial T}{\partial x} \vert}_{x = 0} = {Q}_{0} \\ T ( l , t ) = 0 \\ T ( x , 0 ) = 0\end{matrix} .$$

As for t going to infinity, a steady state solution is obtained, the function T(x,t) has to be written as a summation of a steady state solution and a transient solution. For the steady state solution, the temperature distribution throughout the material will be linear with a gradient giving the heat flux Q:

$$\text{Equation 13:}$$

$$T ( x , ∞ ) = \frac{{Q}_{0}}{k} ( l - x ) .$$

It can be easily verified that this expression is a solution of Equation 11 and fulfils the boundary conditions of Equation 12.

According to the method of separation of variables, a solution of the following form is looked for:

$$\text{Equation 14:}$$

$$T ( x , t ) = \frac{{Q}_{0}}{k} ( l - x ) + g ( t ) \cdot f ( x ) .$$

Substitution into Equation 11 and rearrangement of the terms gives:

$$\text{Equation 15:}$$

$$\frac{1}{a} \frac{\dot{g} ( t )}{g ( t )} = \frac{\ddot{f} ( x )}{f ( x )} = - {m}^{2} ,$$

with m an unknown constant or set of constants.

From the latter equation, the time part can be solved readily:

g(t)=e^{-am}^{²}^{t}. Equation 16:

The x-part of Equation 15 is also easily solvable:

f(x)=A cos(mx)+B sin(mx). Equation 17:

In practice, there will be several values of m allowed, therefore, a general solution for T(x,t) can be written based on an unknown set of coefficients {Aᵢ,Bᵢ,mᵢ}:

$$\text{Equation 18:}$$

$$T ( x , t ) = \frac{{Q}_{0}}{k} ( l - x ) + {\sum }_{i = 0}^{∞} [ {A}_{i} cos ( {m}_{i} x ) + {B}_{i} sin ( {m}_{i} x ) ] \cdot {ⅇ}^{- {am}_{i}^{2} t} .$$

The unknown coefficients {Aᵢ,Bᵢ,mᵢ}, i=0 . . . ∞, must be determined using the boundary conditions, Equation 12.

Taking the condition that at x=1, T≡0:

$$\text{Example 19:}$$

$$T ( l , t ) = \frac{{Q}_{0}}{k} ( l - l ) + {\sum }_{i = 0}^{∞} [ {A}_{i} cos ( {m}_{i} l ) + {B}_{i} sin ( {m}_{i} l ) ] \cdot {ⅇ}^{- a {m}_{i}^{2} t} ≡ 0$$

For random values of t, this can only be accomplished by taking every coefficient of the exponential function zero:

Aᵢ cos(mᵢl)+Bᵢ sin(mᵢl)=0. Equation 20:

This gives a relationship between Aᵢ and Bᵢ:

Bᵢ=−Aᵢ cot g(mᵢl). Equation 21:

Using this expression, Bᵢ can be eliminated from Equation 18:

$$\text{Equation 22:}$$

$$T ( x , t ) = \frac{{Q}_{0}}{k} ( l - x ) + {\sum }_{i = 0}^{∞} {A}_{i} [ cos ( {m}_{i} x ) - cot g ( {m}_{i} l ) sin ( {m}_{i} x ) ] \cdot {ⅇ}^{- a {m}_{i}^{2} t} .$$

It is tried now to fulfil the first boundary condition of Equation 12:

$${ \text{Equation 23:} \\ - \frac{\partial T ( x , t )}{\partial x} \vert}_{x = 0} = - \frac{{Q}_{0}}{k} = - \frac{{Q}_{0}}{k} - {\sum }_{i = 0}^{∞} {A}_{i} [ - {m}_{i} sin ( {m}_{i} x ) + {m}_{i} cot g ( {m}_{i} l ) cos ( {m}_{i} x ) ] \cdot {ⅇ}^{- a {m}_{i}^{2} t} {\vert}_{x = 0}$$

This gives:

$$\text{Equation 24:}$$

$${\sum }_{i = 0}^{∞} {A}_{i} {m}_{i} cot g ( {m}_{i} l ) \cdot {ⅇ}^{- a {m}_{i}^{2} t} ≡ 0.$$

Again, for random values of t, this can only be accomplished by having the coefficient of the exponent equal to zero. One solution is Aᵢ≡0, but this will in the end give the steady state solution, what is really not the solution looked for. A solution for Aᵢ≠0 will only be possible when:

cot g(mᵢl)=0. Equation 25:

This settles a boundary condition for the unknown constants mᵢ. For the above equation, there are an infinite number of solutions. Only the positive solutions will be concentrated on:

$$\text{Equation 26:}$$

$${m}_{i} = ( 2 i + 1 ) \frac{π}{2} \cdot \frac{1}{l} , i = 0 … ∞ .$$

With this boundary condition, Equation 22 can be rewritten:

$$\text{Equation 27:}$$

$$T ( x , t ) = \frac{{Q}_{0}}{k} ( l - x ) + {\sum }_{i = 0}^{∞} {A}_{i} cos ( {m}_{i} x ) \cdot {ⅇ}^{- a {m}_{i}^{2} t} .$$

In a last step, the coefficients Aᵢ have to be searched in order to fulfil the last boundary condition in Equation 12:

$$\text{Equation 28:}$$

$$T ( x , 0 ) = 0 = \frac{{Q}_{0}}{k} ( l - x ) + {\sum }_{i = 0}^{∞} {A}_{i} cos ( {m}_{i} x ) .$$

It can be verified that the functions cos(mᵢx), i=0 . . . ∞, form an orthogonal set of functions over the interval [0,I]. The coefficients Aᵢ can then easily be found as:

$$\text{Equation 29:}$$

$${A}_{i} = - \frac{{Q}_{0}}{k} \frac{{\int }_{0}^{l} ( l - x ) cos ( {m}_{i} x ) ⅆ x}{{\int }_{0}^{l} {cos}^{2} ( {m}_{i} x ) ⅆ x} = \frac{2 {Q}_{0}}{k l {m}_{i}^{2}} .$$

This leads then to the final expression for the temperature in the layer, driven by a constant heat flux Q₀:

$$\text{Equation 30:}$$

$$T ( x , t ) = \frac{{Q}_{0}}{k} ( l - x ) - \frac{2 {Q}_{0}}{k l} {\sum }_{i = 0}^{∞} \frac{1}{{m}_{i}^{2}} cos ( {m}_{i} x ) \cdot {ⅇ}^{- a {m}_{i}^{2} t ,}$$

$$\text{With: Equation 26:}$$

$${m}_{i} = ( 2 i + 1 ) \frac{π}{2} \cdot \frac{1}{l} , i = 0 … ∞ .$$

Expression for the Temperature in a Heater Element.

Consider a heater element that is driven during a time t_{exc} with a value Q₀. After that time, the power is removed until the next line time, t=tₗᵢₙₑ. Assuming that all the heat flows to the heat sink, an upper boundary value is obtained for the temperature in the heater element. It is interesting to know what the fraction of the temperature still will be present at t=tₗᵢₙₑ (latent heat).

The heater element excitation can be looked upon as a superposition of two constant excitations—see FIG. 6. In both cases, we do have an infinite excitation, so that Equation 30 can be applied twice.

The temperature distribution in the considered layer of material equals then the sum of the temperature distributions due to the separate excitations. This because of having a linear system so that the superposition principle can be applied. The temperature distribution can then be written as:

$$\text{Equation 31:}$$

$$T ( x , t ) = \frac{{Q}_{0}}{k} ( l - x ) - \frac{2 {Q}_{0}}{k l} {\sum }_{i = 0}^{∞} \frac{1}{{m}_{i}^{2}} cos ( {m}_{i} x ) \cdot {ⅇ}^{- a {m}_{i}^{2} t} \text{for} t < {t}_{exc} \text{and}$$

$$\text{Equation 32:}$$

$$T ( x , t ) = \frac{2 {Q}_{0}}{k} {\sum }_{i = 0}^{∞} \frac{1}{{m}_{i}^{2}} cos ( {m}_{i} x ) \cdot [ {ⅇ}^{- a {m}_{i}^{2} ( t - {t}_{exc} )} - {ⅇ}^{- a {m}_{i}^{2} t} ] \text{for} t \geq {t}_{exc} .$$

For the moment we only have interest for the heater element temperature T_{HE} itself. This can be found by putting x=0:

$$\text{Equation 33:}$$

$${T}_{HE} = \frac{{Q}_{0} l}{k} - \frac{2 {Q}_{0}}{k l} {\sum }_{i = 0}^{∞} \frac{1}{{m}_{i}^{2}} \cdot {ⅇ}^{- a {m}_{i}^{2} t} \text{for} t < {t}_{exc} \text{and}$$

$$\text{Equation 34:}$$

$${T}_{HE} = \frac{2 {Q}_{0}}{k l} {\sum }_{i = 0}^{∞} \frac{1}{{m}_{i}^{2}} \cdot [ {ⅇ}^{- a {m}_{i}^{2} ( t - {t}_{exc} )} - {ⅇ}^{- a {m}_{i}^{2} t} ] \text{for} t \geq {t}_{exc} .$$

It can be proven that for t=t_{exc}, Equation 33 and Equation 34 will give identical values. At t=t_{exc}, the highest heater element temperature will be reached:

$$\text{Equation 35:}$$

$${T}_{max} = \frac{2 {Q}_{0}}{k l} {\sum }_{i = 0}^{∞} \frac{1}{{m}_{i}^{2}} \cdot [ 1 - {ⅇ}^{- a {m}_{i}^{2} {t}_{exc}} ] .$$

Latent Heat Accumulation in the Heater Element.

For the sake of simplicity and generality, it is interesting to introduce a dimensionless time. Therefore, Equation 36 is put forward:

$$\text{Equation 36:}$$

$$τ = \frac{a {π}^{2}}{4 {l}^{2}} t [ \frac{{m}^{2}}{s} \cdot \frac{1}{{m}^{2}} \cdot s ] .$$

The maximum temperature attained in the heater element can then be rewritten as (Equation 35, Equation 26):

$$\text{Equation 37:}$$

$${T}_{max} = \frac{8 l {Q}_{0}}{k {π}^{2}} {\sum }_{i = 0}^{∞} \frac{1}{{( 2 i + 1 )}^{2}} \cdot [ 1 - {ⅇ}^{- {( 2 ⅈ + 1 )}^{2} {τ}_{exc}} ] .$$

The latent temperature of the heater element at t=tₗᵢₙₑ (this is at the start of a new line print) can easily be found using Equation 34:

$$\text{Equation 38:}$$

$${T}_{line} = \frac{8 l {Q}_{0}}{k {π}^{2}} {\sum }_{i = 0}^{∞} \frac{1}{{( 2 i + 1 )}^{2}} \cdot [ {ⅇ}^{- {( 2 ⅈ + 1 )}^{2} ( {τ}_{line} - {τ}_{exc} )} - {ⅇ}^{- {( 2 ⅈ + 1 )}^{2} {τ}_{line}} ] .$$

It is interesting to consider the value of Tₗᵢₙₑ relative to Tₘₐₓ:

$$\text{Equation 39:}$$

$$\frac{{T}_{line}}{{T}_{max}} = \frac{{\sum }_{i = 0}^{∞} \frac{1}{{( 2 i + 1 )}^{2}} \cdot [ {ⅇ}^{- {( 2 ⅈ + 1 )}^{2} ( {τ}_{line} - {τ}_{exc} )} - {ⅇ}^{- {( 2 ⅈ + 1 )}^{2} {τ}_{line}} ]}{{\sum }_{i = 0}^{∞} \frac{1}{{( 2 i + 1 )}^{2}} \cdot [ 1 - {ⅇ}^{- {( 2 ⅈ + 1 )}^{2} {τ}_{exc}} ]} .$$

For a practical example, this ratio can be plotted for increasing values of τₗᵢₙₑ. The thermal resistance in the thermal head coming from the ceramic layer is considered, as described in Table 1. Abstraction is made of a slicer based control scheme of the heater element and it is assumed that it is driven with a mean excitation time of 5 ms. In that case, the numerical value of τ_{exc} can be calculated (Equation 36):

$${τ}_{exc} = \frac{a {π}^{2}}{4 {l}^{2}} t = \frac{7.5 {10}^{- 6} \cdot {π}^{2}}{4 \cdot {10}^{- 6}} \cdot 5 \cdot {10}^{- 3} = 92.5 \cdot {10}^{- 3} .$$

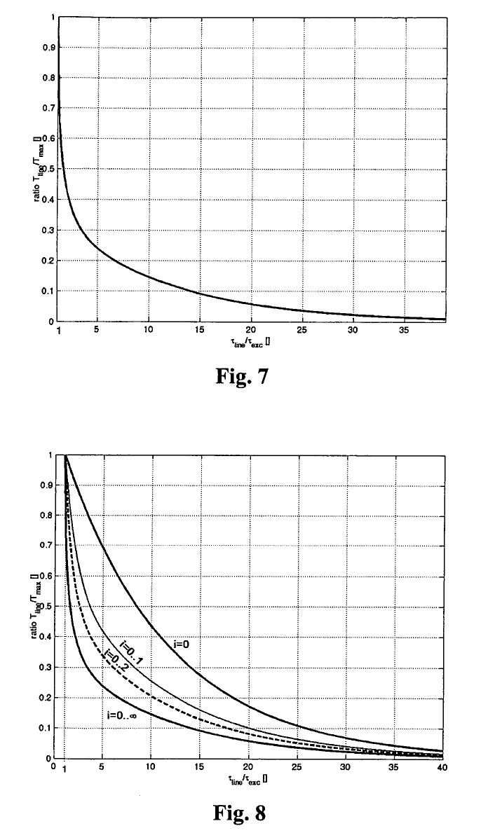

For different line times, the temperature present when starting the second line can be calculated—see FIG. 7. There is a significant drop in the latent temperature, although this is very relative as one tends to keep tₗᵢₙₑ/t_{exc} as small as possible, giving the fastest printing rates for the printer device.

During the calculation, it turned out that the series from Equation 39 did show a slow convergence rate. Therefore, it is not possible to simply make an approximation by setting only i=0. To illustrate this, the same curve of FIG. 7 has been recalculated with some limited iteration rates—see FIG. 8. Using only the very first term gives an exponential approximation with a single time constant. This in fact corresponds to the classical RC-network that is used in many publications. One can clearly notice that a single exponential curve gives insufficient approximation accuracy for the rapidly changing regions.

We can now come to the definition of tₗᵢₙₑ. In fact, every definition of tₗᵢₙₑ is OK as any deviation from that state can be recalculated using the thermal model established above. But as the model is based on experimental measurements, it is important to make sure that the measurement taken does not interfere with a transient pixel size, e.g. because the temperature in the heater element has not yet been stabilised. A steady state situation is reached whenever at the start of the line, the temperature of the heater element is identical to that of the proceeding line. In practice, this will never be the case considering the erfo-function behaviour of the heat flow. Therefore, a practical limit is put, e.g. a 1% error. An analytical expression is constructed for the history of the heater element temperature when an infinite amount of identical pixels are being printed with an excitation time t_{exc} and a line time tₗᵢₙₑ.

For knowing the temperature of the heater element at the line number N, a linear superposition can be made of the contributions al all the lines printed in the past. Therefore, the latent temperature can easily be written as summation of Equation 39 with increasing line time:

$$\text{Equation 40:}$$

$$\frac{{T}_{LineN}}{{T}_{max}} = {\sum }_{j = 1}^{N} \frac{{\sum }_{i = 0}^{∞} \frac{1}{{( 2 i + 1 )}^{2}} \cdot [ {ⅇ}^{- {( 2 ⅈ + 1 )}^{2} ( j \cdot {τ}_{line} - {τ}_{exc} )} - {ⅇ}^{- {( 2 ⅈ + 1 )}^{2} j \cdot {τ}_{line}} ]}{{\sum }_{i = 0}^{∞} \frac{1}{{( 2 i + 1 )}^{2}} \cdot [ 1 - {ⅇ}^{- {( 2 ⅈ + 1 )}^{2} {τ}_{exc}} ]} ,$$

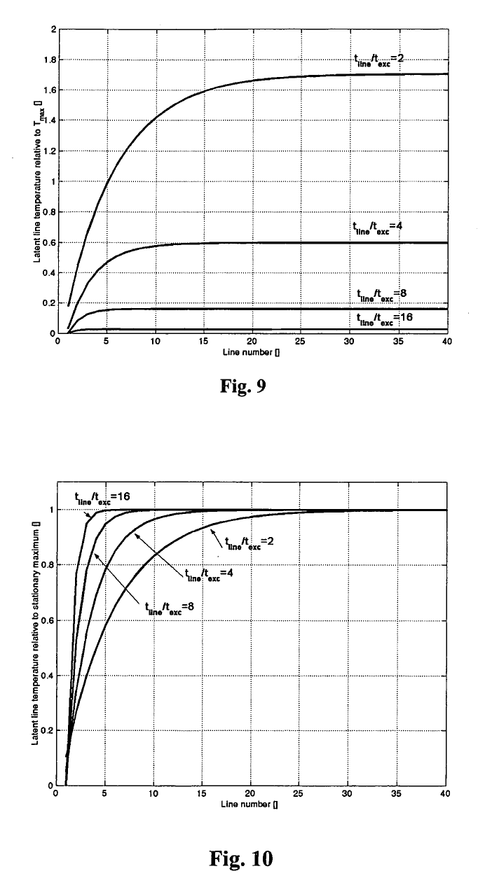

with T_{lineN} the starting temperature of the heater element at line N in case the periodic printing job did start in line 0. For increasing values of N, T_{lineN} will converge as the contributions for large j-values in the above summation drop significantly. This is illustrated based on the numerical example of FIG. 7. For tₗᵢₙₑ/t_{exc}=2, 4, 8 and 16, the transient response has been calculated using Equation 42 for a great number of lines—see FIG. 9. One notices that for short line times, a serious temperature accumulation can occur in the heater element. For tₗᵢₙₑ/t_{exc}=2, the latent temperature increases up to 1.8 times Tₘₐₓ (the maximum temperature rise reached in the heater element in the active print period).

It can be noticed that for large ratio's of tₗᵢₙₑ/t_{exc}, the transient response stabilises very quickly. In order to have a better comparison on the transient behaviour, the curves have been scaled relatively to each other—FIG. 10. For large line times, only a few lines need to be printed to reach a steady state situation.

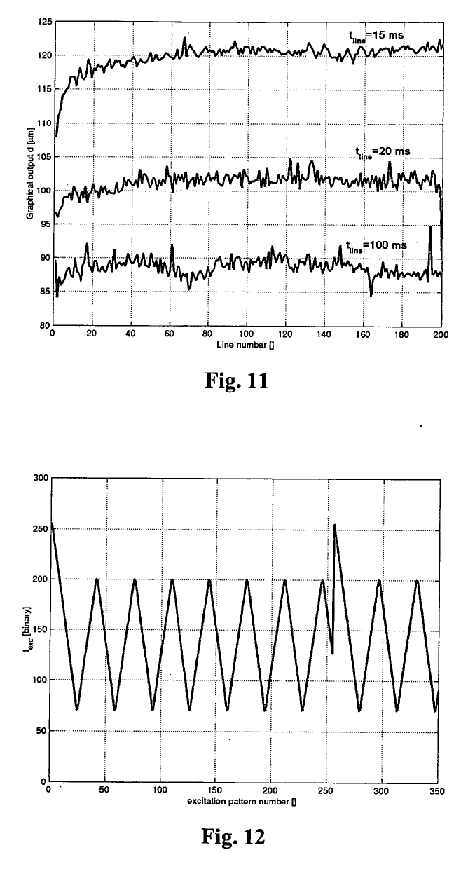

Above theoretical pictures can be experimentally assisted with measurement data showing the increase of the line thickness due to latent heat accumulation—see FIG. 11. The purpose of this picture is to illustrate the different transient behaviour for changing line time (cfr. FIG. 9).

Definition of tₗᵢₙₑ for a Real Print Head Consisting of a Multi-Layered Structure.

In the previous paragraph, the heat accumulation in the heater element due to an important thermal resistance present in the thermal head structure was considered. This has been illustrated with some calculations around a ceramic support layer. A commercial thermal head mostly consists of a variety materials like e.g. a heater element deposited on a thin glass layer, being supported by a ceramic layer and being mounted on an aluminium heat sink. The definition of tₗᵢₙₑ in such a situation is now considered.

As an example, Table 1 is taken again. The heater element 4 has been deposited on a 50 μm glass layer 20, being deposited on 1 mm ceramic 22 which in turn is mounted on a large heat sink 24.

TABLE 1
Calculated diffusion times for two
material layers in a thermal head.

| | ρ | K | | | thickness | |
|---|---|---|---|---|---|---|
| Material | [kg/m³] | [W/mK] | c [J/kg] | a [m²/s] | [μm] | t_{d} [ms] |
| ceramic | 4000 | 24 | 800 | 7.50e−6 | 1000 | 42.4 |
| glass | 3500 | 1.1 | 720 | 4.37e−7 | 50 | 1.82 |
| Aluminium | 2700 | 235 | 885 | 98.3e−6 | 30000 | 6311 |

For this construction, a range of diffusion times can be seen. This has to be related to the excitation time of the heater elements 4 and the line time. The heater element supporting glass layer 20 has a relatively small diffusion time. This means that during the excitation period itself, a steady state temperature profile can easily be reached in the glass layer 20. The purpose of the glass layer 20 is to create a thermal barrier, giving a very high temperature itself in the heater element 4. In fact, this is the primary purpose of the heater element 4 as it has to thermally excite a thermosensitive material 10, brought into contact at the surface area of the heater element 4.

The diffusion time of the ceramic layer 22 is 42 ms and is in practice a little larger than the line time. The assumption has been made that all the heat generated in the heater element 4 flows to the heat sink 24. In practice, this is not the case but for the moment, it is a very good approximation and will given a save value of tₗᵢₙₑ found. As the glass layer 22 has only a very small diffusion time, the approximation can be made that the heat Q developed on top of the glass layer 22 instantaneously can increase the temperature so fast that it will induce a constant Q-flux into the ceramic layer 22. Using the theory established above, the transient behaviour of the latent temperature on the surface of the ceramic layer 22 can be calculated. From this calculation, a lower boundary can be put on the line time as to make the measurement on the graphical output not to interfere with the transient thermal behaviour of the heater element 4.

Although the heat sink 24 has mostly a good thermal conductivity, the distance from a location near by the heater elements 4 (under the ceramic support 22) to a temperature sensor is mostly large and gives much longer diffusion times than the one of the ceramic layer 22. The purpose of the reference printing state is the ability to establish a relationship between the measurement of the temperature in the heat sink 24 and the graphical printout d made by the heater element 4. For this, it is necessary to have a correct relationship between the heat sink temperature and the latent heat present in the heater element 4. When generating a transient situation when starting a periodic printout of pixel values, it is important to wait until a steady state relationship has been settled between the heater element latent temperature and the measured heat sink temperature. But in this case, things are not that bad. The heat flux Q coming from the heater element 4 has to be averaged over the whole line printing period. This is because the upper layers work as a kind of low-pass filter and the heat sink 24 will only see the time averaged heat coming from the heater elements 4:

$$\text{Equation 41:}$$

$${Q}_{HeatSink} = {Q}_{nib} \frac{{t}_{exc}}{{t}_{line}} .$$

As tₗᵢₙₑ already is large compared to t_{exc} to avoid a long transient of the ceramic layer 22, Q_{HeatSink} will be small and give a constant temperature rise at the ceramic-Aluminium (heat sink 24) interface. This temperature rise can be estimated using a constant heat flux from Equation 41 when applying Equation 30 for the heat sink structure.

As a conclusion, a real hard definition of tₗᵢₙₑ can not really be made as it depends very much on the construction of the thermal head 2. But from an engineering point of view, the following calculation of tune will give very acceptable results:

The line time tₗᵢₙₑ must be selected so as to give a printout that should be in steady state regime at those places where the graphical characterisation of the deposited printout is made (being pixel size estimation or optical density). For its determination, that material layer in the process is selected that will have a diffusion time that is much larger than the nib excitation time and has the same order of magnitude as the line time. For this layer, starting from t_{exc},τ_{exc} can be calculated (Equation 36). Using the equation:

$$\text{Equation 40:}$$

$$\frac{{T}_{LineN}}{{T}_{max}} = {\sum }_{j = 1}^{N} \frac{{\sum }_{i = 0}^{∞} \frac{1}{{( 2 i + 1 )}^{2}} \cdot [ {ⅇ}^{- {( 2 ⅈ + 1 )}^{2} ( j \cdot {τ}_{line} - {τ}_{exc} )} - {ⅇ}^{- {( 2 ⅈ + 1 )}^{2} j \cdot {τ}_{line}} ]}{{\sum }_{i = 0}^{∞} \frac{1}{{( 2 i + 1 )}^{2}} \cdot [ 1 - {ⅇ}^{- {( 2 ⅈ + 1 )}^{2} {τ}_{exc}} ]} ,$$

for different values of τₗᵢₙₑ (or tₗᵢₙₑ), the transient behaviour of the latent heat in the heater element 4 can be simulated and tₗᵢₙₑ can be chosen as to make the measurements on the graphical system not to interfere with the transient period. Whenever there are more thermal diffusion time constants with the same magnitude, one must refer to numerical simulations in order to estimate the number of lines the transient will be present or make a few experimental printouts and check it manually. In our opinion, it is best to choose tₗᵢₙₑ as to have a transient in the graphical output that only will take a few lines, this is that Tₗᵢₙₑ must be settled to e.g. 95% in less than 5 lines. If necessary, corrections can be made for the heat sink temperature measured based on a constant time averaged energy flux to the heat sink (cfr. Equation 30 and Equation 41).

Caution should be taken whenever apart from t_{exc}, also some reduced energy is given to the heater element 4 because of limitations in the electric driver circuit. The time period the reduced energy is delivered sometimes can be large compared to t_{exc} and ultimately, give some important contribution to the total Q-value produced in the heater element 4.

Practical Definition of the Reference Printing State.

A reference printing state and the accompanied reference printout is built upon the following constraints:

the line time tₗᵢₙₑ should be larger than the time calculated based upon the theory from the paragraph “assessment of a line time tₗᵢₙₑ that gives a controlled error on the T_{HS} value in the nib itself” and defined in “definition of tₗᵢₙₑ for a real print head consisting of a multi-layered structure”.

the printing pattern should be chosen carefully so as to have no cross-talk between the image data present in the graphical output (e.g. a line pattern with enough spacing) and also that the graphical image allows to characterise the graphical output by the necessary measurement techniques, e.g. macro or micro densitometry.

during the printing process, a continuously recording should be possible of the printing parameters defining the graphical output, being the arguments from Equation 3. A posteriori, it must be possible to trace back for every part of the graphical output, the value of these printing parameters. Things can be simplified by printing special patterns that allow to trace back more easily the printing state.

it is allowed to have small transient regions in the graphical output where there is an uncertainty about the driving parameters used at that time because of transients. Measurement of the graphical output function d, should not interfere with these transient zones, as at that spot, no correct relation can be established with the driving parameters like t_{exc}, T_{HS} and other parameters.

the measured heat sink temperature T_{HS} should be put into relation with those nibs that are close to the measurement point of T_{HS}. Also, it is best to have a uniform heating of the thermal head by making the printout of the reference picture over all the length of the thermal head.

Characterisation of the Graphical Output With Regard to the Printing Parameters.

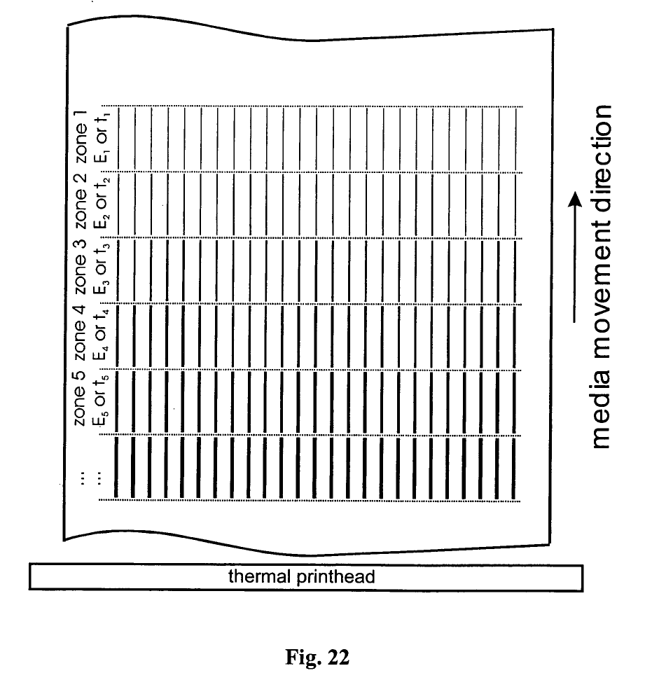

Whenever the reference printing state of the thermal printer has been defined, together with the graphical output patterns that are fit for characterising the graphical output function d and being exempt of any cross talk, several printouts can be made. An example of a print pattern used for the calibration printout is shown in FIG. 22. The print pattern consists of zones zone 1-zone 5 along the scan direction of the thermal printhead, in the example given horizontal zones. Each zone uses a constant value for the excitation energy Eᵢ or excitation time tᵢ. The pattern being printed consists of vertical lines. Therefore every zone comprises a plurality of pixel lines, producing a pattern on the thermal media, like e.g. the line pattern of FIG. 22, allowing a direct measurement of the graphical output d (density or pixel size) by macro densitometry.

During the printing process, the several parameters defining the graphical output (Equation 3) are recorded. Normally, this is not obvious with the standard firmware of the printing device and therefore, will require a special firmware version. This will be clarified hereunder.

The target is to establish a explicit relationship for:

d=f(T_{HS},t_{exc},<other parameters>) Equation 3:

With an “explicit” relationship is meant:

a numerical table giving for a random combination of T_{HS}, t_{exc} and if present, another parameter or a plurality of other parameters, the value of d (representing the graphical output). But this relation must be commutative. Whenever d is given as well as all the other parameters, except for one, then that parameter must be traceable, as to give then the desired value of d. Example: find t_{exc} when T_{HS}, d and the other parameters are known.

a system of approximation functions, e.g. polynomial functions with definable coefficients, splines, parameterised transcendental functions or combinations of the just described functions, then can be determined using state of the art numerical approximation techniques, mostly based on statistical principles.

To be able to correctly express this explicit relationship, a recording of a wide range and a rich set of combinations of the several parameters defining the graphical output is necessary. It is e.g. impossible to put a relationship between d and T_{HS} for a value of T_{HS} that never has been reached during the printout. Whenever T_{HS} is defined to be e.g. between the range of 15° C. to 45° C., it is important to have a graphical record for this whole temperature range, if necessary induced by external means (e.g. a heater).

Also, during the printout, a span of the t_{exc} is assumed to be present. If printing only with a constant t_{exc} value, the statistical information with regard to t_{exc} in Equation 3 will not be very valuable. Therefore, the firmware of the printer should be altered, allowing it to use different values of the heater element excitation time t_{exc} or energy. This again gives a range of t_{exc} values that can be statistically linked with a range of graphical output's d. At the same time, this should be linked to a range of changing values of the other parameters as well, improving the correlation between d and the parameters T_{HS}, t_{exc}, . . . .

This will be illustrated with a practical example. The printer firmware has been modified so as to obtain a variable value of t_{exc} when printing a line pattern. For every 100 lines, t_{exc} was kept constant and then changed to a new value—FIG. 12. Also, in the pattern being printed, some information was present, indicating the start of a zone with a new t_{exc} value. The printer was able to drive every heater element 4 with an excitation time having a resolution of 8 bit. It is assumed that the graphical output has been linearised regarding the t_{exc} value. This means that for monotone rising values of t_{exc}, the graphical output also behaves monotonically, but not necessarily linear.

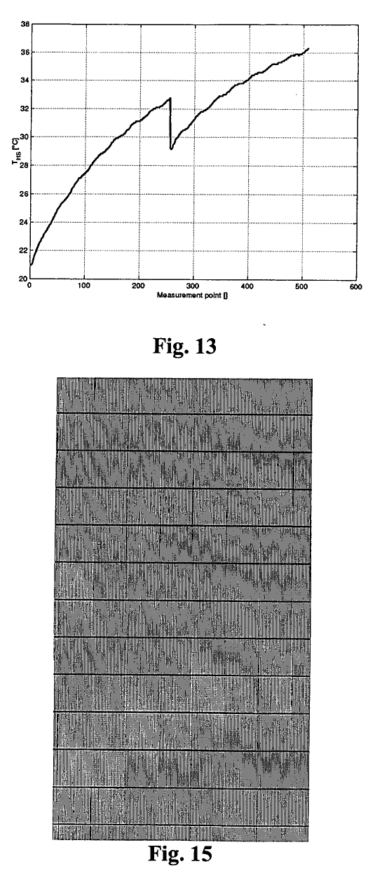

When making the printout with for every t_{exc}, about 100 lines being printed, the heat sink temperature will increase slowly. This temperature has been recorded as well—see FIG. 13.

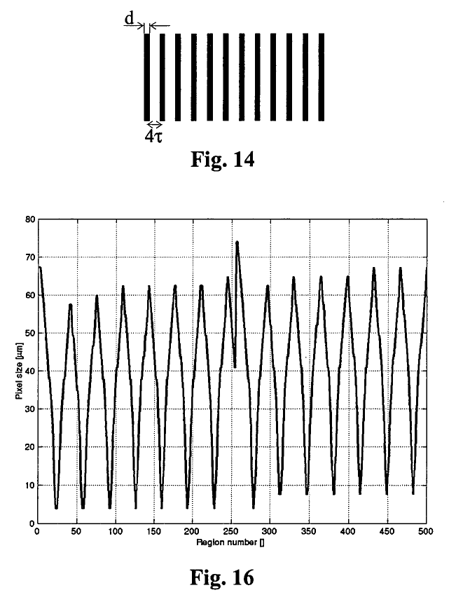

For the characterisation of the graphical output, the accent was lying on the pixel size, as in the present case there is dealt with a graphical application. A pattern of vertical lines has been printed, using a pattern 1000100010001000 . . . For the heater elements 4, as shown in FIG. 14, ‘1’ meaning that the heater element is excited, ‘0’ for no excitation. When the excited nibs are four separated from each other, no cross-talk could be observed for the printing device used.

The thickness d of the line is taken as a representative parameter for the pixel size. The relation between the macro optical density value and the line thickness is given by:

$$\text{Equation 42:}$$

$$D = {log}_{10} ( \frac{4 τ}{4 τ - d} ) .$$

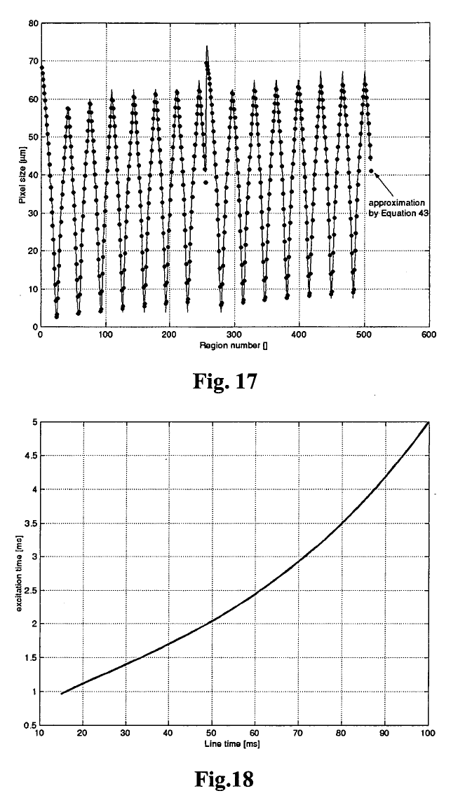

As mentioned before, about a 100 lines were printed with a constant t_{exc} value—see FIG. 15. During the first few lines, transients will be present because of a little change of latent heat in the heater element itself, but this value could be neglected by an appropriate choice of the line time (100 ms). Using a macro density meter, the optical density of the line pattern is measured and the d-value is calculated using Equation 42—see FIG. 16.

For this experiment, no other parameters, such as for example humidity of the graphical emulsion layer, have been considered, but of course this could be done by a person skilled in the art.

It has been decided to use a polynomial approximation for the function f in Equation 3, being identical for all the nibs in the print head:

d=f(T_{HS},t_{exc})=(a₂T_{HS}+a₁T_{HS}²+a₀)t_{exc}²+(b₂T_{HS}²+b₁T_{HS}+b₀)t_{exc}+(c₂T_{HS}²+c₁T_{HS}+c₀).

This expression contains 9 constants that may be determined by any suitable means, e.g. in the example given using a least square approximation—see FIG. 17. As a least square approximation is being used, it is preferred to have a wide range of d values mixed with a wide range of T_{HS} and t_{exc} values. Otherwise, in the determination of the constants, most weight will be put on those values occurring most often. In the present example, only 2 points have been printed with a t_{exc} weight of 255. The least square errors for this point will not contribute much to the total sum of least squares and therefore, the approximation will allow a greater error for these points, as can be noticed in FIG. 17 for region number 250.

For very small values of t_{exc}, it is not possible to make a graphical output as the energy in the heater elements is much too small. This implies that the extrapolation from Equation 43 to small values of t_{exc} will give impractical values for d. But in practice, this gives no problem as d will be imposed by the graphical process and shall always be lying in the visible region. A greater problem can be imposed for the range of T_{HS}. As can be noticed from FIG. 13, during the experiment, the temperature range goes from 20 up to 36° C. Beyond this region, there is no certainty that Equation 43 will behave correctly. Therefore, the experiments should have been repeated over and over again until the whole working temperature region has been covered. This will give a lot of measurement data which should be used in the one fit process for finding the coefficients of Equation 43.

Whenever the fitting process fails to give a good approximation for all the points, this can mean several things:

the form of the approximation function is wrong, e.g. the polynomial degree is too low to accurately model the non linear image forming process,

the reference printing state of the printer exhibits transient phenomena which extend over a very large number of lines in every region of constant t_{exc}. This gives inconsistent measured data (d-values are different for same t_{exc} values, depending on whether t_{exc} is rising or falling), making a good correlation fit impossible.

the relation between t_{exc} and t is discontinuous in nature because of errors in the lookup table relating a t_{exc} value with an electrical waveform that has to be sent to the heater element.

Construction of a Compensation Scheme for Printing Under Conditions Deviating From the Reference Printing State.

The main conditions for the reference printing scheme were a rather long line time tₗᵢₙₑ allowing the heater element to cool down again and therefore to prevent cross-talk between the several nibs, as in that case t_{exc} becomes offset.

From this moment on, compensation is done. This means that the t_{exc} value that must be used is given by:

Equation 44: t_{exc}=f⁻¹(d_{wanted})|_{T}_{_{HS}}_{,<other params>,}−tₗₐₜₑₙₜt_{crosstalk}.

This expression assumes that latent heat and heat coming from cross-talk can directly be assigned to the domain of time excitation. For strongly non-linear graphic forming materials, it is possible that the latent heat part should give a correction on T_{HS} in the above equation, working at that moment in the heat sink temperature domain and not in the excitation time domain.

The issue of cross-talk is not discussed here, as it depends strongly on the physical construction of the head. Cross-talk effects run only on a short time frame and can be handled directly in the time excitation domain. Cross-talk effects are considered here as being a direct effect, this is that pixels printed simultaneously influence each other. Pixels also produce latent heat in neighbouring pixels on later lines. This should not be regarded as cross-talk but as a special form of latent heat.

Concerning the latent heat, the correction comes from the fact that for the real printing process, the line time will be kept as short as possible. Heat generated in a heater element will not be vanished before the next time the heater element is excited on the next print line.

Latent Heat Generated by Altered Line Time.

Whenever for the reference printout, the graphical printing process has been characterised by the relationship:

d=f(T_{HS},t_{exc},<other parameters>) Equation 3:

it might be interesting to know how this relationship will change whenever the line time changes. Only the static deviation of the equation will be looked for. This means that corrections to the above equation are tried to be made under the prevalent constraints of the reference printout.

There is looked for a correction on t_{exc} to compensate for an increased value of tₗᵢₙₑ. If the reference model has been built based on a line time tₗᵢₙₑ^{ref}, a latent temperature can be found at the beginning of each line being equal to Tₗᵢₙₑ^{ref}. When the line time changes to tₗᵢₙₑ, the latent temperature will also change to a value Tₗᵢₙₑ. In order to make Tₗᵢₙₑ equal to Tₗᵢₙₑ^{ref}, a correction must be made on t_{exc}, namely Δt_{exc}. This value can easily be derived using Equation 38:

$$\text{Equation 45:}$$

$$\begin{matrix}{T}_{line}^{ref} = \frac{8 l {Q}_{0}}{k {π}^{2}} {\sum }_{i = 0}^{∞} \frac{1}{{( 2 i + 1 )}^{2}} \cdot [ {ⅇ}^{- {( 2 ⅈ + 1 )}^{2} ( {τ}_{line}^{ref} - {τ}_{exc} )} - {ⅇ}^{- {( 2 ⅈ + 1 )}^{2} {τ}_{line}^{ref}} ] \\ = \frac{8 l {Q}_{0}}{k {π}^{2}} {\sum }_{i = 0}^{∞} \frac{1}{{( 2 i + 1 )}^{2}} \cdot [ {ⅇ}^{- {( 2 ⅈ + 1 )}^{2} ( {τ}_{line} - ( {τ}_{exc} + Δ {τ}_{exc} ) )} - {ⅇ}^{- {( 2 ⅈ + 1 )}^{2} {τ}_{line}} ] .\end{matrix}$$

Further simplification gives:

$$\text{Equation 46:}$$

$${\sum }_{i = 0}^{∞} \frac{1}{{( 2 i + 1 )}^{2}} \cdot [ {ⅇ}^{- {( 2 ⅈ + 1 )}^{2} ( {τ}_{line}^{ref} - {τ}_{exc} )} - {ⅇ}^{- {( 2 ⅈ + 1 )}^{2} {τ}_{line}^{ref}} ] = {\sum }_{i = 0}^{∞} \frac{1}{{( 2 i + 1 )}^{2}} \cdot [ {ⅇ}^{- {( 2 ⅈ + 1 )}^{2} ( {τ}_{line} - ( {τ}_{exc} + Δ {τ}_{exc} ) )} - {ⅇ}^{- {( 2 ⅈ + 1 )}^{2} {τ}_{line}} ] .$$

A closed expression for Δτ_{exc} is not possible and one must refer to a non-linear root finder (e.g. Newton-Raphson). Whenever tune is smaller than tₗᵢₙₑ^{ref}, Δt_{exc} will be negative. As an illustrative example, the excitation time is calculated relative to a 100 ms line time. The reference excitation time used at the 100 ms line time was 5 ms. The new excitation time is calculated for smaller line times with the purpose of getting the same Tₘₐₓ in the nib and as a consequence, the same graphical output in the steady state situation—see FIG. 18. The transient history of the image will be different, but to compensate for this, another compensation technique must be used.

Referring to FIG. 20, there is shown a global principle schema of a thermal printing apparatus 30 that can be used in accordance with the present invention (known from e.g. EP-0 724 964, in the name of Agfa-Gevaert). This apparatus is capable of printing lines of pixels (or picture elements) on a thermographic recording material m, comprising thermal imaging elements or (shortly) imaging elements, often symbolised by the letters le. As an imaging element le is part of a thermographic recording material m, both are indicated in the present specification by a common reference number 10. The thermographic recording material m comprises on a support a thermosensitive layer, and generally is in the form of a sheet. The imaging element 10 is mounted on a rotatable platen or drum 12, driven by a drive mechanism (not shown) which continuously advances (see arrow Y representing a so-called slow-scan direction 38) the drum 12 and the imaging element 10 past a stationary thermal print head 2. This head 2 presses the imaging element 10 against the drum 12 and receives the output of the driver circuits (not shown in FIG. 20 for the sake of greater clarity). The thermal print head 2 normally includes a plurality of heater elements 4 equal in number to the number of pixels in the image data present in a line memory. The imagewise heating of the heater element 4 is performed on a line by line basis (along a so-called fast-scan direction X which generally is perpendicular to the slow-scan direction Y), the “line” may be horizontal or vertical depending on the configuration of the printer, with the heating resistors of the heater elements 4 geometrically juxtaposed each along another and with gradual construction of the output density. Each of these resistors is capable of being energised by heating pulses, the energy of which is controlled in accordance with the required density of the corresponding picture element. As the image input data 32 have a higher value, the output energy increases and so the optical density of the hardcopy image 34 on the imaging element 10. On the contrary, lower density image data 32 cause the heater energy to be decreased, giving a lighter picture 34.

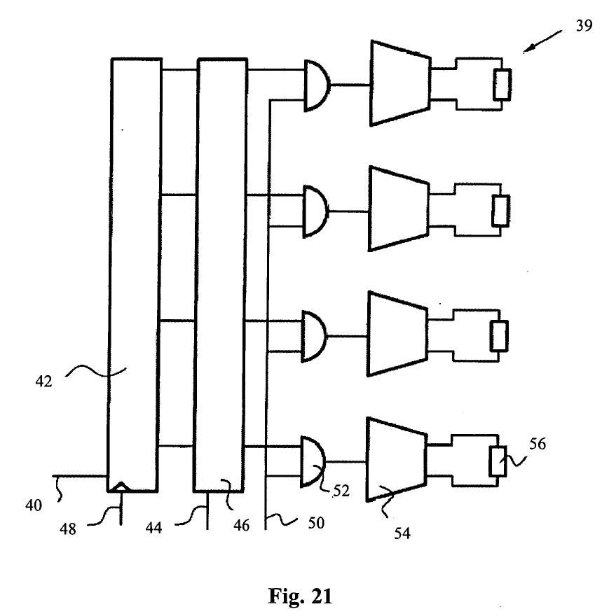

The activation of the heater elements 4 is preferably executed pulse wise and preferably by digital electronics. Some steps up to activation of said heater elements are illustrated in FIG. 20 and in the activation device 39 of FIG. 21. First, input image data 32 are applied to a processing unit 36. After processing and parallel to serial conversion (not shown) of the digital image signals, a stream of serial data of bits is shifted (via serial input line 40) into a shift register 42, thus representing the next line of data that is to be printed. Thereafter, under control of a latch enabling line 44, these bits are supplied in parallel to the associated inputs of a latch register 46. Once the bits of data from the shift register 42 are stored in the latch register 46, another line of bits can be sequentially clocked (see ref. Nr. 48) into said shift register 42. A strobe signal 50 controls AND-gates 52 and feeds the data from latching register 46 to drivers 54, which are connected to heater elements 56. These drivers 54 (e.g. transistors) are selectively turned on by a control signal in order to let a current flow through their associated heater elements 56.

The recording head or print head 2 is controlled so as to produce in each pixel the density value corresponding with the processed digital image signal value. In this way a thermal hard-copy 34 of the electrical image data is recorded. By varying the heat applied by each heater element to the carrier, a variable density image pixel is formed. The thermal printing apparatus 30 is therefore provided with a control unit 38. The control unit 38 may include a computing device, e.g. microprocessor, for instance it may be a microcontroller. In particular, it may include a programmable printer controller, for instance a programmable digital logic element such as a Programmable Array Logic (PAL), a Programmable Logic Array, a Programmable Gate Array, especially a Field Programmable Gate Array (FPGA). The use of an FPGA allows subsequent programming of the printer device, e.g. by downloading the required settings of the FPGA. This control unit 38 may be adapted to establish a mathematical model by first making a reference printout on the thermographic material 10, said reference printout consisting of several printed regions 34 with each of the several printed regions 34 being printed with a different constant amount of heat energy Eᵢ delivered to the heater elements 4, to thereafter determine a measure of the graphical output dᵢ for each of the several printed regions 34 measured in a zone of each region where the graphical output dᵢ was printed in a thermal steady state, and to establish the mathematical model by determining a best fit relationship between the measures of the graphical output dᵢ and the constant amounts of heat energy. The control unit 38 may furthermore be adapted to determine a heat energy to be supplied to at least one energisable heater element 4 in accordance with the mathematical model for printing of an image on a thermographic material 10 using a thermal printing system comprising a thermal printer having a thermal print head 2 incorporating a plurality of energisable heater elements 4.

It is to be understood that although preferred embodiments have been discussed herein for devices according to the present invention, changes or modifications in form and detail may be made without departing from the scope and spirit of this invention. For example the heater elements may be electrically excited heater elements based on the Joule effect, directly (conductively) or indirectly (capacitively, inductively or RF) supplied from a voltage source. Alternatively, the heater elements may be based on a light or IR to heat conversion. In still another embodiment, the heater elements may be based on exothermal chemical, biological or pyrotechnic controllable reactions.

1. A method for generating a mathematical model of thermal steady state printing characteristics of a thermal printing system using a computing device, the thermal printing system comprising a thermal printer having a thermal head (2) incorporating a plurality of energisable heater elements (4) and a heat sink (24), and a thermographic material (10), said method comprising:
making a reference printout on the thermographic material (10), said reference printout consisting of several printed regions with each of the several printed regions being printed with a different steady state amount of heat energy (Eₙ) delivered to the heater elements (4),
determining a measure of the graphical output (dₙ) in function of at least a parameter relating to the heat sink temperature for each of the several printed regions measured in a zone of each region where the graphical output (dₙ) was printed in a thermal steady state,
establishing the mathematical model by determining a best fit relationship between the measures of the graphical output (dₙ) in function of at least the parameter related to the heat sink temperature and the steady state amounts of heat energy (Eₙ).

2. A method according to claim 1, wherein the heat energy is represented by a given equivalent time (t_{exc}) used for powering the heater element (4) with an equivalent constant power (P₀), Eₙ=t_{exc}*P₀.

3. A method according to claim 1, furthermore comprising, while making the reference printout, logging of parameters (Pⱼ) that are determinative to the graphical output (dₙ).

4. A method according to claim 1, comprising establishing a table (T) of data comprising the steady state graphical output function (dₙ), and the used energy (Eₙ or t_{exc}) giving an implicit relationship between the graphical output function (dₙ) and its controlling parameters (Eₙ or t_{exc}).

5. A method according to claim 4, the table (T) furthermore comprising the parameters (Pₙ) that are determinative to the graphical output (dₙ).

6. A method according to claim 4, wherein the best fit relationship is a parametrisable function (f( )), being defined by a set of unknown coefficients (a,b,c,d, . . . ) found using a curve fitting process on the table (T).

7. The method according to any of claim 1, wherein a printing pattern of said reference printout is selected so that the pixels being printed do not interact with each other.

8. The method according to claim 1 wherein the best fit relationship is given by dᵢ=f(t_{exc}) where t_{exc} is an excitation time of a heater element and this relationship is corrected when using the printing system at a different line time by adding an offset At_{exc} to t_{exc}, Δt_{exc} being found as the value that full-fills the equation
$${\sum }_{i = 0}^{∞} \frac{1}{{( 2 i + 1 )}^{2}} \cdot [ {ⅇ}^{- {( 2 ⅈ + 1 )}^{2} ( {τ}_{line}^{ref} - {τ}_{exc} )} - {ⅇ}^{- {( 2 ⅈ + 1 )}^{2} {τ}_{line}^{ref}} ] = {\sum }_{i = 0}^{∞} \frac{1}{{( 2 i + 1 )}^{2}} \cdot [ {ⅇ}^{- {( 2 ⅈ + 1 )}^{2} ( {τ}_{line} - ( {τ}_{exc} + Δ {τ}_{exc} ) )} - {ⅇ}^{- {( 2 ⅈ + 1 )}^{2} {τ}_{line}} ] .$$

9. The method according to claim 1, wherein said graphical output (dₙ) is a pixel with a certain colour spectral density in the centre of the pixel and/or a pixel with a certain size defined by a perimeter having a given colour spectral density, to be reproduced on said thermographic material (10).

10. A method for driving a thermal print head of a thermal printing system comprising a thermal printer having the thermal print head (2) incorporating a plurality of energisable heater elements (4) and a heat sink (24), and a thermographic material (10), said method comprising:
in a first mode establishing a mathematical model by:
making a reference printout on the thermographic material (10), said reference printout consisting of several printed regions with each of the several printed regions being printed with a different constant amount of heat energy (Eₙ) delivered to the heater elements (4),
determining a measure of the graphical output (dₙ) in function of at least a parameter related to the heat sink temperature for each of the several printed regions measured in a zone of each region where the graphical output (dₙ) was printed in a thermal steady state,
establishing the mathematical model by determining a best fit relationship between the measures of the graphical output (dₙ) and the constant amounts of heat energy, and,
in a second mode:
determining a heat energy to be supplied to at least one energisable heater element (4) in accordance with the mathematical model for printing of an image on a thermographic material (10) using a thermal printing system comprising a thermal printer having a thermal print head (2) incorporating a plurality of energisable heater elements (4) and a heat sink (24), and a current value of the parameter related to the heat sink temperature.

11. A method according to claim 10, wherein the heat energy is represented by a given equivalent time (t_{exc}) used for powering the heater element (4) with an equivalent constant power (P₀), Eₙ=t_{exc}*P₀.

12 A method according to claim 10, furthermore comprising, while making the reference printout, logging of parameters (Pⱼ) that are determinative to the graphical output (dₙ).

13. A method according to claim 10, comprising establishing a table (T) of data comprising the steady state graphical output function (dₙ), and the used energy (Eₙ or t_{exc}), giving an implicit relationship between the graphical output function (dₙ) and its controlling parameters (Eₙ or t_{exc}).

14. A method according to claim 13, the table (T) furthermore comprising the parameters (Pₙ) that are determinative to the graphical output (dₙ).

15. A method according to claim 13, wherein the best fit relationship is a parametrisable function (f( )), being defined by a set of unknown coefficients (a,b,c,d, . . . ) found using a curve fitting process on the table (T).

16. A method according to claim 10, wherein a printing pattern of said reference printout is selected so that the pixels being printed do not interact with each other.

17. A method according to claim 10, wherein the best fit relationship is given by dᵢ=f(t_{exc}) where t_{exc} is an excitation time of a heater element and this relationship is corrected when using the printing system at a different line time by adding an offset Δt_{exc} to t_{exc}, Δt_{exc} being found as the value that full-fills the equation
$${\sum }_{i = 0}^{∞} \frac{1}{{( 2 i + 1 )}^{2}} \cdot [ {ⅇ}^{- {( 2 ⅈ + 1 )}^{2} ( {τ}_{line}^{ref} - {τ}_{exc} )} - {ⅇ}^{- {( 2 ⅈ + 1 )}^{2} {τ}_{line}^{ref}} ] = {\sum }_{i = 0}^{∞} \frac{1}{{( 2 i + 1 )}^{2}} \cdot [ {ⅇ}^{- {( 2 ⅈ + 1 )}^{2} ( {τ}_{line} - ( {τ}_{exc} + Δ {τ}_{exc} ) )} - {ⅇ}^{- {( 2 ⅈ + 1 )}^{2} {τ}_{line}} ] .$$

18. A method according to claim 10, wherein said graphical output (dₙ) is a pixel with a certain colour spectral density in the centre of the pixel and/or a pixel with a certain size defined by a perimeter having a given colour spectral density, to be reproduced on said thermographic material (10).

19. A control unit for use with a thermal printer for printing an image onto a thermographic material, the thermal printer having a thermal head incorporating a plurality of energisable heater elements, the control unit being adapted to control the driving of the thermal printer so as to make a reference printout on the thermographic material, said reference printout consisting of several printed regions, the driving of the thermal printer being such that each of the several printed regions is printed with a different constant amount of heat energy delivered to the heater elements, the control unit furthermore being adapted to determine a measure of the graphical output for each of the several printed regions measured in a zone of each region where the graphical output was printed in a thermal state, and the control unit furthermore being adapted to establish a mathematical model of thermal steady state printing characteristics by determining a best fit relationship between the measures of the graphical output and the constant amounts of heat energy.

20. A control unit according to claim 19, the control unit furthermore being adapted for determining a heat energy to be supplied to at least one energisable heater element in accordance with the mathematical model.

21. A thermal print head provided with a control unit according to claim 19.

22. A computer program product for executing the method as claimed in claim 1 when executed on a computing device associated with a thermal print head.

23. A machine readable data storage device storing the computer program product of claim 22.
